(19) United States
(12) Patent Application Publication
(10) Pub. No.: US 2026/0253271 A1
(43) Pub. Date: Aug. 27, 2026

(54) METHOD AND SYSTEM FOR EXAGGERATION OF REACTION OF ONE OR MORE GRAPHICAL REPRESENTATIONS IN A VIRTUAL ENVIRONMENT

(71) Applicant: SAMSUNG ELECTRONICS CO., LTD., Suwon-si (KR)

(72) Inventors: Natasha MEENA, Noida (IN); Rajat KUMAR, Noida (IN)

(73) Assignee: SAMSUNG ELECTRONICS CO., LTD., Suwon-si (KR)

(21) Appl. No.: 19/649,990

(22) Filed: Apr. 16, 2026

Related U.S. Application Data
(63) Continuation of application No. PCT/KR2024/006639, filed on May 16, 2024.

(30) Foreign Application Priority Data
Oct. 19, 2023 (IN) 202311071596

(51) Int. Cl. G06T 11/10; G06F 40/35; G10L 25/63

(52) U.S. Cl. CPC G06T 11/10; G06F 40/35; G10L 25/63

(57) ABSTRACT

A method and a system of controlling a reaction of one or more avatars in a virtual environment. The disclosed methodology performs contextual analysis on conversational data in real time between two or more avatars. The disclosed methodology further determines an emotional reaction state based on the contextual analysis. The disclosed methodology further determines an exaggeration level and emotion indicators of the one or more avatars with respect to the emotional reaction state. The disclosed methodology further determines space configuration values corresponding to the one or more avatars, respectively, for configuring the surrounding virtual space for exaggeration of the reaction of the one or more avatars based on the emotional reaction state, the emotion indicators, and the exaggeration level. Based on the space configuration values the avatars are controlled in the virtual space.

### CROSS-REFERENCE TO RELATED APPLICATION

This application is a continuation application, under 35 U.S.C. § 111(a), of international application No. PCT/KR2024/006639, filed on May 16, 2024, which claims priority under 35 U. S. C. § 119 to Indian Patent Application No. 202311071596, filed on Oct. 19, 2023, the disclosures of which are incorporated herein by reference in their entireties.

### TECHNICAL FIELD

The present disclosure generally relates to a virtual environment. In particular, the present disclosure relates to a method and a system for exaggeration of a reaction of one or more avatars in a virtual environment.

### BACKGROUND ART

In recent years, avatars have become an integral part of various digital applications. The avatars are the graphical representations that are widely used in gaming, social networking, and even marketing. These graphical representations (hereinafter ‘avatars’) characterize the users to express themselves in various ways. As an example, by using animated avatars during messaging, the users are provided with a dynamic and captivating medium for self-expression. This enables the users to express their emotions and moods in a better way.

According to the current trend, various social platforms are widely employing avatars to enhance the user experience during virtual conversation. According to some conventional techniques, camera related operations are used to express emotions of the users. In particular, camera filters are used to create effects on the user's face to exaggerate emotions.

Further, various efforts were made to improve an emotional depth of the avatars. According to some conventional solutions, the avatars are made from an image of the user or based on a user input. Further, some solutions offer an option to search for avatars based on specific emotions. Thus, the users are provided with a range of expressive possibilities. According to some conventional solutions, a photograph of the user is used as a basis for assigning a best matching feature from a pre-existing set of features for creating the avatar of the user, thus, ensuring a close resemblance of the user. Furthermore, some conventional solutions provide a comprehensive toolset for creating avatars. The users can customize their avatars by adjusting colors, selecting suitable templates, and picking fonts and the like.

However, despite these advancements, there are still limitations to existing solutions. For example, existing solutions are limited to the creation and modification of the avatars based either on the existing database or tool set. In case the users may want to amplify their emotions for artistic or dramatic effect, the conventional solution fails to provide any solution in this regard. Furthermore, avatar creation and modification based on emotions mostly revolves around the avatar's facial expression and lacks provisions to add imaginary information to the avatar.

Thus, there is a need to provide a methodology to overcome the above-mentioned issues in the conventional techniques.

### DISCLOSURE OF INVENTION

### Solution to Problem

According to an embodiment of the present disclosure, a method of controlling of a reaction of one or more graphical representations in a virtual environment is disclosed. The method includes obtaining conversational data corresponding to a conversation in real time between two or more graphical representations in a virtual space of the virtual environment and relational data associated with a relation between the one or more graphical representations. Thereafter, the method includes determining an emotional reaction state associated with the one or more graphical representations based on a contextual analysis of the conversational data and the relational data. The method further includes determining, based on a plurality of parameters associated with the emotional reaction state, an exaggeration level corresponding to the emotional reaction state and a plurality of emotion indicators with respect to the emotional reaction state. Thereafter, the method includes determining, for the one or more graphical representations based on configuration of a plurality of space parameters for a space point among a plurality of space points in the virtual space with respect to the plurality of emotion indicators and the exaggeration level, a plurality of space configuration values for the plurality of space points, respectively. The method further includes determining final configuration values corresponding to the one or more graphical representations, respectively, based on a correlation between initial configuration values assigned to the one or more graphical representations, respectively, and the space configuration values corresponding to the plurality of graphical representations. The method further includes controlling the reaction reflected by the one or more graphical representations in the virtual space of the virtual environment by simulating the one or more graphical representations based on the final configuration values.

According to an embodiment, a system of controlling a reaction of one or more graphical representations in a virtual environment is provided. The system comprises a memory to store one or more computer programs and one or more processors communicatively coupled to the memory. The one or more processors execute the one or more computer programs or at least one instruction stored in the memory to cause the system to obtain conversational data corresponding to real time conversation between two or more graphical representations in a virtual space of the virtual environment and relational data associated with a relation between the one or more graphical representations. Thereafter, the one or more processors execute the program or at least one instruction stored in the memory to cause the system to determine an emotional reaction state associated with the one or more graphical representations based on a contextual analysis of the conversational data and the relational data. The one or more processors execute the one or more computer programs or at least one instruction stored in the memory to cause the system to determine, based on a plurality of parameters associated with the emotional reaction state, an exaggeration level corresponding to the emotional reaction state and a plurality of emotion indicators with respect to the emotional reaction state. Thereafter, the one or more processors execute the one or more computer programs or at least one instruction stored in the memory to cause the system to determine, for the one or more graphical representations based on configuration of a plurality of space parameters for a space point among a plurality of space points in the virtual space with respect to the plurality of emotion indicators and the exaggeration level, a plurality of space configuration values for a space point. The one or more processors execute the one or more computer programs or at least one instruction stored in the memory to cause the system to determine final configuration values corresponding to the one or more graphical representations based on a correlation between initial configuration values assigned to the one or more graphical representations and the space configuration values corresponding to the plurality of graphical representations. The one or more processors execute the program or at least one instruction stored in the memory to cause the system to control the reaction reflected by the one or more graphical representations in the virtual space of the virtual environment to simulate the one or more graphical representations based on the final configuration values.

According to an embodiment of the disclosure, a computer-readable medium storing computer-executable instructions executable by a system cause the system to perform the method is provided. The method includes obtaining conversational data corresponding to a conversation in real time between two or more graphical representations in a virtual space of the virtual environment and relational data associated with a relation between the one or more graphical representations. Thereafter, the method includes determining an emotional reaction state associated with the one or more graphical representations based on a contextual analysis of the conversational data and the relational data. The method further includes determining, based on a plurality of parameters associated with the emotional reaction state, an exaggeration level corresponding to the emotional reaction state and a plurality of emotion indicators with respect to the emotional reaction state. Thereafter, the method includes determining, for the one or more graphical representations based on configuration of a plurality of space parameters for a space point among a plurality of space points in the virtual space with respect to the plurality of emotion indicators and the exaggeration level, a plurality of space configuration values for each space point. The method further includes determining final configuration values corresponding to the one or more graphical representations based on a correlation between initial configuration values assigned to the one or more graphical representations and the space configuration values corresponding to the plurality of graphical representations. The method further includes controlling the reaction reflected by the one or more graphical representations in the virtual space of the virtual environment by simulating the one or more graphical representations based on the final configuration values.

To further clarify the advantages and features of the present disclosure, a more particular description of the disclosure will be rendered by reference to specific embodiments thereof, which is illustrated in the appended drawing. It is appreciated that these drawings depict only typical embodiments of the disclosure and are therefore not to be considered limiting its scope. The disclosure will be described and explained with additional specificity and detail with the accompanying drawings.

### BRIEF DESCRIPTION OF DRAWINGS

These and other features, aspects, and advantages of the present disclosure will become better understood when the following detailed description is read with reference to the accompanying drawings in which like characters represent like parts throughout the drawings, wherein:

FIG. 1 illustrates an example for the exaggeration of the reaction of one or more avatars in the virtual environment, according to an embodiment of the present disclosure;

FIG. 2 illustrates an exemplary general architecture of a system according to an embodiment of the present disclosure;

FIG. 3 illustrates a high-level architecture of the system, according to an embodiment of the present disclosure;

FIG. 4 illustrates an operational flow of the system, according to an embodiment of the present disclosure;

FIG. 5 illustrates a flow chart of the operation flow, according to an embodiment of the present disclosure;

FIG. 6 illustrates an example operation of the emotional reaction state (S) determination for a sample conversational data, according to an embodiment of the present disclosure;

FIG. 7 illustrates an example operation of the exaggeration level determination for a probability emotional reaction state (L) and the relation, according to an embodiment of the present disclosure;

FIG. 8 illustrates an example of bodily sensation map (BSMs) corresponding to an anger emotion, according to an embodiment of the present disclosure;

FIG. 9A illustrates an example of state-symbol dataset, according to an embodiment of the present disclosure;

FIG. 9B illustrates an example of emotion-temperature association, according to an embodiment of the present disclosure;

FIG. 10 illustrates an example working of state-data association mechanism, for a sample emotional reaction state, according to an embodiment of the present disclosure;

FIG. 11 illustrates an example of a single space point in the augmented/virtual space, according to an embodiment of the present disclosure;

FIG. 12 illustrates examples of an adaptive space configuration, according to an embodiment of the present disclosure;

FIG. 13 illustrates an example working of space subset configuration and space point configuration, according to an embodiment of the present disclosure;

FIG. 14 illustrates an example of body points on the user's avatar and configuring body points, according to an embodiment of the present disclosure;

FIG. 15 illustrates a working of avatar-space reaction determination, according to an embodiment of the present disclosure;

FIG. 16 illustrates an example of avatar exaggeration for various states, according to an embodiment of the present disclosure;

FIG. 17 illustrates an example scenario of intelligently Exaggerate avatar's state while chatting, according to an embodiment of the present disclosure;

FIG. 18 illustrates an example scenario of creating a various exaggerated avatars based on user's selection, according to an embodiment of the present disclosure;

FIG. 19 illustrates an example scenario of creating and exaggerating avatars in real-time during video calling, according to an embodiment of the present disclosure.

FIG. 20 depicts an example of different states for a given ambient mode, according to an embodiment of the present disclosure; and

FIG. 21 illustrates an example of exaggerating social media status of the avatar, according to an example embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### MODE FOR THE INVENTION

It should be understood at the outset that although illustrative implementations of the embodiments of the present disclosure are illustrated below, the present disclosure may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

It is to be understood that the singular forms “a,” “an,” and “the” include plural referents unless the context clearly dictates otherwise. Thus, for example, reference to “a component surface” includes reference to one or more of such surfaces.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments, to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching, and illuminating some embodiments and their specific features and elements and does not limit, restrict, or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element does NOT preclude there being none of that feature or element, unless otherwise specified by limiting language such as “there NEEDS to be one or more . . . ” or “one or more element is REQUIRED.”

It should be appreciated that the blocks in each flowchart and combinations of the flowcharts may be performed by one or more computer programs which include computer-executable instructions. The entirety of the one or more computer programs may be stored in a single memory or the one or more computer programs may be divided with different portions stored in different multiple memories.

Any of the functions or operations described herein can be processed by one processor or a combination of processors. The one processor or the combination of processors is circuitry performing processing and includes circuitry like an application processor (AP), a communication processor (CP), a graphical processing unit (GPU), a neural processing unit (NPU), a microprocessor unit (MPU), a system on chip (SoC), an IC, or the like

Unless otherwise defined, all terms, and especially any technical and/or scientific terms, used herein may be taken to have the same meaning as commonly understood by one having ordinary skill in the art.

Embodiments of the present disclosure will be described below in detail with reference to the accompanying drawings.

According to an embodiment, the present disclosure discloses a method and a system for exaggeration of a reaction of one or more avatars in a virtual environment. According to an embodiment, the disclosed methodology performs contextual analysis of conversational data in real time between two or more avatars. The avatars are the graphical representations of the user in a virtual space in the virtual environment. The disclosed methodology further determines an emotional reaction state based on the contextual analysis. In an embodiment, the emotional reaction state indicates a reaction of the one or more avatars in response to the conversational data. The disclosed methodology further determines an exaggeration level and emotion indicators of the one or more avatars with respect to the emotional reaction state. In an embodiment, the exaggeration level indicates a measure of extremeness of intensity associated with the emotional reaction state and the emotion indicators indicate reaction parameters that are likely to be affected with respect to the emotional reaction state. As an example, the reaction parameters include one or more of a color of a skin of the one or more avatars, a plurality of body attributes of the one or more avatars, a temperature associated with the plurality of body attributes of the one or more avatars, a plurality of symbols with respect to the emotional reaction state, a charge associated with the plurality of body attributes of the one or more avatars, or a gravity of the associated with the plurality of body attributes of the one of more avatars and the like. The disclosed methodology further determines space configuration values corresponding to each of the one or more avatars for configuring the surrounding virtual space for exaggeration of the reaction of the one or more avatars based on the emotional reaction state, the emotion indicators, and the exaggeration level. Further, a final configuration values corresponding to each of one or more avatars are determined by correlating an initial configuration values corresponding to the each of one or more avatars with the space configuration values corresponding to each of the plurality of avatars. Accordingly, based on the final configuration values the avatars are exaggerated in the virtual space. The detailed methodology is explained in the following paragraphs.

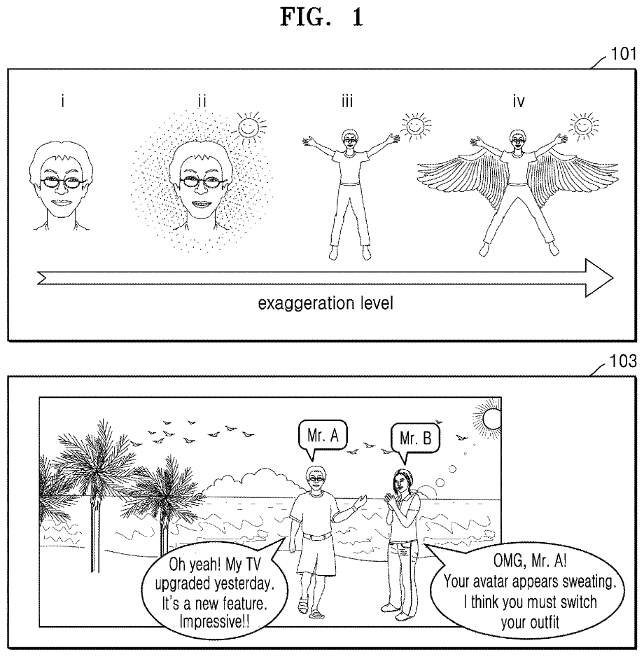

FIG. 1 illustrates an example for the exaggeration of the reaction of one or more avatars in the virtual environment, according to an embodiment of the present disclosure. The scenario depicted at block 101 shows various levels of exaggeration levels depicting the exaggeration of the reaction in the avatars of the depicted user. According to an embodiment, a higher intensity of state, i.e., the exaggeration level, is reflected on and around the avatar, by changing the space properties in ii), iii), and iv) of block 103. Further, the scenario depicted at block 103 shows a VR space of a beach including two avatars (i.e., Mr. A and Ms. B indulging in real time conversations with each other. In the exemplary scenario of block 103, the avatar Mr. A is shown wearing winter clothes and Ms. B is shown wearing summer clothes. Considering the above-mentioned scenario, the temperature of the avatar Mr. A is increased which makes her avatar react to sweat. In an example, if the temperature increases further, the color of the space around Mr. A may be modified so as to start to turn red. Thus, in an example, the emotion indicators may change the avatar from sweating to turning into red and then finally the space around turn into red, as the exaggeration level is increased. A detailed methodology is explained in the following paragraphs of the disclosure.

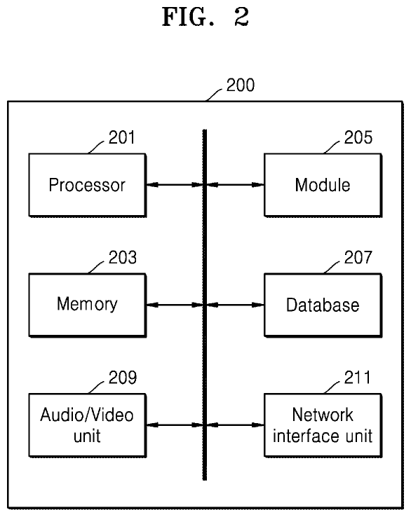

FIG. 2 illustrates an exemplary general architecture of a system 200 according to an embodiment of the present disclosure. The system 200 is configured to implement a method for exaggeration of the reaction of one or more avatars in the virtual environment. The system 200 includes at least one processor 201, a memory 203, at least one module 205, a database 207, an Audio/Video (AV) unit 209, and a network interface (NI) 211 coupled with each other.

As an example, the system 200 may be implemented in various electronic devices. In an embodiment, the electronic device implementing the system 200 may include a Personal Computer (PC), tablet, smartphone, a desktop computer, or any other machine capable of executing a set of instructions related to implementation of a metaverse environment. According to some embodiment, the system 200 may be implemented at a cloud server which is further connected with the Personal Computer (PC), a desktop computer, and the like for implementing the metaverse environment.

In an example, the processor 201 may be a single processing unit or a number of units, all of which could include multiple computing units. The processor 201 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor 201 is configured to fetch and execute computer-readable instructions and data stored in the memory 203.

The memory 203 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes. In an embodiment, the memory 203 may store program for exaggeration of a reaction of one or more graphical representations in a virtual environment.

As an example, the module 205 may include a program, a subroutine, a portion of a program, a software component, or a hardware component capable of performing a stated task or function. As used herein, the module 205 may be implemented on a hardware component such as a server independently of other modules, or a module can exist with other modules on the same server, or within the same program. The module 205 may be implemented on a hardware component such as processor one or more microprocessors, microcomputers, microcontrollers, digital signal processors, central processing units, state machines, logic circuitries, and/or any devices that manipulate signals based on operational instructions. The module 205 when executed by the processor 201 may be configured to perform any of the described functionalities. In an embodiment, as the module 205 is implemented by the program, the module 205 may be stored in the memory 203.

As a further example, the database 207 may be implemented with integrated hardware and software. The hardware may include a hardware disk controller with programmable search capabilities or a software system running on general-purpose hardware. The examples of the database 207 are, but are not limited to, in-memory databases, cloud databases, distributed databases, embedded databases, and the like. The database 207, amongst other things, serves as a repository for storing data processed, received, and generated by one or more of the processors, and the modules/engines/units.

In an embodiment, the module 205 may be implemented using one or more AI modules that may include a plurality of neural network layers. Examples of neural networks include but are not limited to, Convolutional Neural Network (CNN), Deep Neural Network (DNN), Recurrent Neural Network (RNN), Restricted Boltzmann Machine (RBM). Further, ‘learning’ may be referred to in the disclosure as a method for training a predetermined target device (for example, a robot) using a plurality of learning data to cause, allow, or control the target device to make a determination or prediction. Examples of learning techniques include but are not limited to supervised learning, unsupervised learning, semi-supervised learning, or reinforcement learning. At least one of a plurality of CNN, DNN, RNN, RMB models and the like may be implemented to thereby achieve execution of the present subject matter's mechanism through an AI model. A function associated with an AI module may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). One or a plurality of processors control the processing of the input data in accordance with a predefined operating rule or artificial intelligence (AI) model stored in the non-volatile memory and the volatile memory. The predefined operating rule or artificial intelligence model is provided through training or learning.

As an example, the AV unit 209 receives audio data and video data from any third party. As a further example, the NI unit 211 establishes a network connection with a network like a home network, a public network, or a private network and the like.

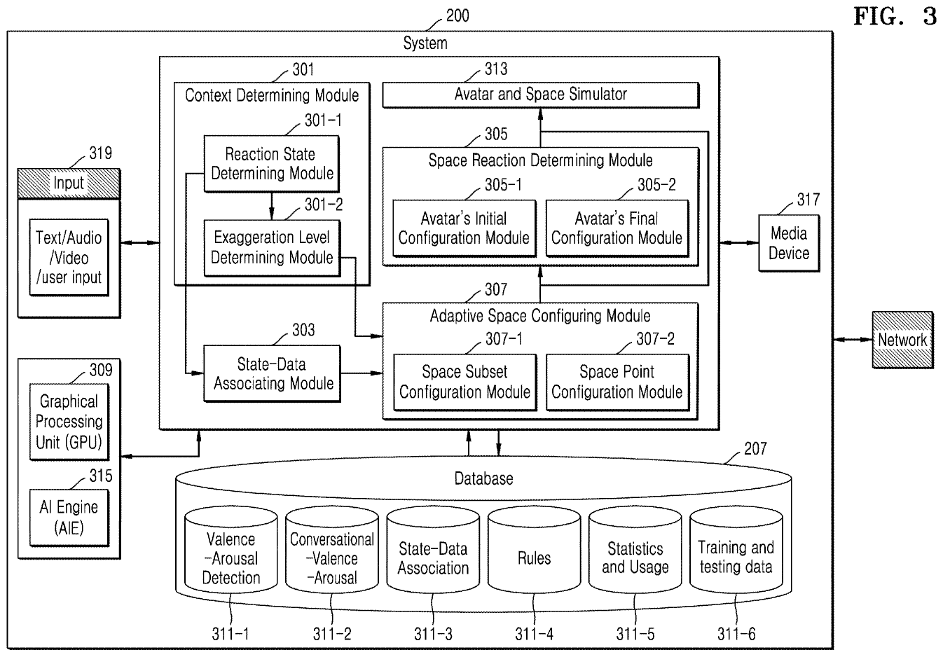

FIG. 3 illustrates a high-level architecture of the system of FIG. 2, according to an embodiment of the present disclosure. In an embodiment, the module 205 of the system 200 further include a context determining module 301, a state-data associating module 303, a space reaction determining module 305, and an adaptive space configuring module 307 coupled and collectively operating with each other. The aforementioned modules are further coupled with the graphical processing unit 309, an Artificial Intelligence (AI) engine 315, a database 207, and a media device 317 and collectively operate with each other.

In an embodiment, the context determining module 301 further includes a reaction state determination module 301-1 and an exaggeration level determining module 301-2 coupled and collectively work with each other. Further, the database 207 of the system 200 further includes a plurality of databases including a valence arousal detection 311-1, a conversational valence arousal 311-2, a state-data association 311-3, rules 311-4, a statistics and usage 311-5, and training and testing data 311-6. According to an embodiment, various functions of the module 205 can be performed by the processor 201 of FIG. 2. However, for ease of understanding, an explanation is provided with respect to various modules. In embodiment module may be a set of instructions that may be stored in memory. The processor executes the set of instructions thereby performing operation of these modules.

According to an embodiment, the media device 317 include at least a display, a graphical user interface (GUI), and a camera for displaying an exaggerated avatars via the media devices 317. A brief working of each of the modules will be described in the forthcoming paragraphs.

According to an embodiment, the context determining module 301 is configured to determine the emotional reaction state (S) based on the real-time conversational data between the two or more avatars and relational data. In an example, the relational data indicates relation between the two or more avatars in the virtual space. The relational data may be obtained based on user input, historical data, user profile data, and the like. As explained above, the emotional reaction state (S) indicates a reaction of the one or more avatars in response to the conversational data. The emotional reaction state (S) may be alternatively referred to as a reaction state (S) throughout the disclosure. From the emotional reaction state, the exaggeration level of the avatars is determined depending upon the emotional reaction state and the relation data between the avatars.

According to an embodiment, the state data associating module 303 determines the emotion indicators associated with the emotional reaction state. As an example, the emotion indicators indicate reaction parameters that are likely to be affected with respect to the emotional reaction state. The emotion indicators indicate, the reaction parameters for example a color, a temperature, a body parts that are likely to be affected with respect to the emotional reaction state. Accordingly, the reaction parameters include one or more of a color of a skin of the one of more avatars, a plurality of body attributes of the one of more avatars, a temperature associated with the plurality of body attributes of the one of more avatars, a plurality of symbols with respect to the emotional reaction state, a charge associated with the plurality of body attributes of the one of more avatars, or a gravity of the associated with the plurality of body attributes of the one or more avatars, and the like.

According to a further embodiment, the adaptive space configuring module 307 determines a space subset value and a space point value corresponding to each of the one or more avatars for configuring the surrounding virtual space. In an embodiment, the space subset value is determined for providing an extra-exaggeration factor that is included in a corresponding subset of each of the one or more avatars in the virtual space. Further, the space point value is the corresponding point in the virtual space. The space point values are further used as space configuration values (S_{conf}) for configuring the surrounding virtual space.

According to an embodiment, the space reaction determining module 305 determines the avatar's final configuration value. In an embodiment, the avatars usually are defined with an initial configuration value. According to an embodiment, the final configuration value is determined along with the extra-exaggeration factor and the space configuration value to depict exaggeration levels in the avatars. As an example, the initial configuration value of the avatars are the configuration provided based on user input, parameters assigned by the system during initial configuration and the like. Further, the final configuration values are the final value that are assigned for exaggerating the avatars.

According to a further embodiment, the avatar and space simulator 313 simulates the avatars with the final configuration value and the space configuration values render the exaggerating avatar and space as output on a display of the system 200.

As an example, the input 319 are conversational data and the relation of one avatar with one or more avatars in the virtual environment. As an example, the conversational data may include the real time conversation between the one or more avatars. As an example, the conversational data may be a text input, an audio input, a video input, a user input, and the like,

A detailed working, and explanation of the various modules of FIG. 3 will be explained in detail in the forthcoming paragraphs. A detailed working of the system 200 will be explained through various components of FIG. 2 in the forthcoming paragraphs through FIGS. 1 to 17.

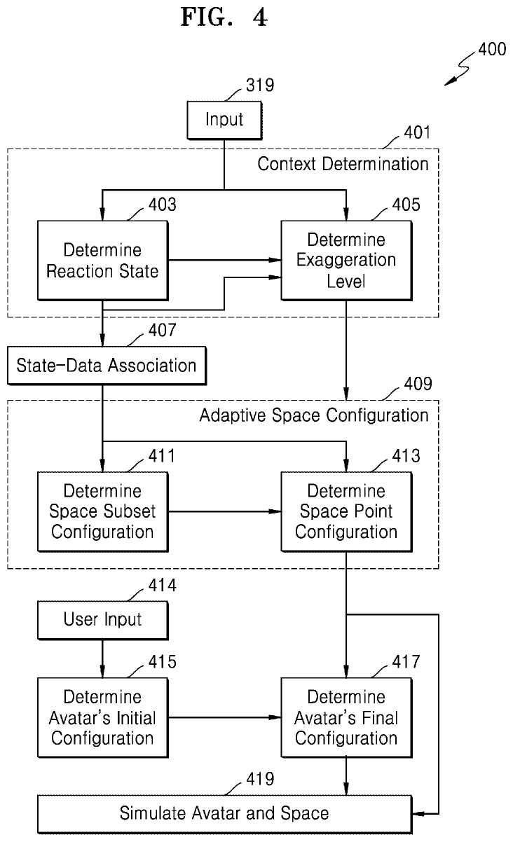

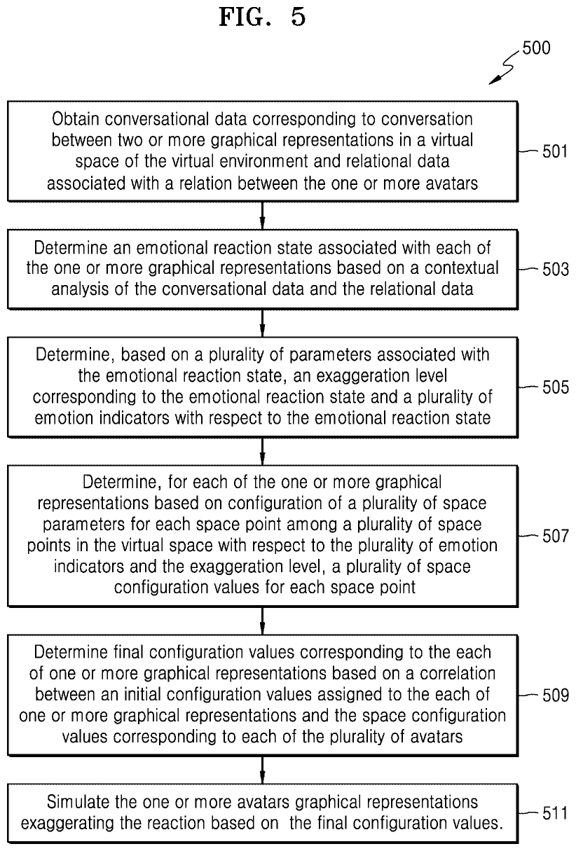

FIG. 4 illustrates an operational flow of the system 200, according to an embodiment of the present disclosure. The operation flow 400 is implemented in the system 200 and will be explained through various operations 401 to 419. Further, FIG. 5 illustrates a flow chart of the operation flow 400 and hence will be explained collectively with the operation flow 400 for the sake of brevity and ease of reference. Accordingly, an explanation of the operation flow 400 will be explained in the forthcoming paragraphs and through FIGS. 1 to 21 Further, the reference numerals were kept the same for the similar components throughout the disclosure for ease of explanation and understanding.

In an embodiment, initially, input 319 is provided to the context determining module 301. In an embodiment, the input 319, for the context determining module 301, may include the conversational data and the relation of one avatar with one or more avatars in the virtual environment. As an example, the conversational data may include the real time conversation between the one or more avatars. As an example, the conversational data may be a text input, an audio input, a video input, a user input, and the like. As a further example, the relation of one avatar with one or more avatars may include relations like friends, colleagues, siblings, parents, and the like. Accordingly, the processor 201 obtains the conversational data and the relational data associated with a relation between the one or more avatars at operation 501 of FIG. 5.

In an embodiment, the conversational data corresponding to real time conversation between two or more avatars and the relational data associated with the relation between the one or more avatars is provided as the input 319 to the context determining module 301. In an embodiment, the context determining module 301 determines, at operation 401, the emotional reaction state (S) associated with each of the one or more avatars and the exaggeration level (E). In particular, the reaction state determining module 301-1 determines the emotional reaction state (S) at operation 403, and the exaggeration level determining module 301-2 determines the exaggeration level (E) at operation 405. The detailed working of the operations 403 and 405 will be explained in the forthcoming paragraphs.

According to an embodiment, based on the conversational data and the relational data, the reaction state determining module 301-1 of the context determining module 301, at operation 403, determines the emotional reaction state (S) associated with each of the one or more avatars by performing a contextual analysis of the conversational data and the relational data. In particular, the input conversational data is processed to predict a plurality of parameters associated with the emotional reaction state. The plurality of parameters associated with the emotional reaction state includes an emotional valence parameter (Vc), an emotional arousal parameter (Ac), and a probability of the emotional reaction state (L) of the one or more avatars.

In an embodiment, the emotional valence parameter (Vc) indicates a measure of pleasure of the one or more avatars. The emotional arousal parameter (Ac) indicates a physiological state of the one or more avatars. The physiological state of the one or more avatars indicates one of a proactive or inactive state of the one or more avatars. The emotional valence parameter (Vc) and the emotional arousal parameter (Ac) together signify the physical state of a user and are hence referred to as the emotional reaction state (S) or the reaction state (S). Accordingly, based on the contextual analysis of the conversational data, the reaction state determining module 301-1 determines a plurality of parameters associated with the emotional reaction state (reaction state S).

According to an embodiment, the emotional reaction state (S) determination is performed by using a recurrent neural network (RNN) model with an attention mechanism to capture the dynamics of conversation by utilizing an utterance encoder, a context encoder, and an attention mechanism. The output of the RNN model is the emotional reaction state (S) of the user, in terms of a value of the emotional valence parameter (Vc), and the emotional arousal parameter (Ac) from the conversational data is given by equation 1.

$$S = \{ {V}_{C} , {A}_{c} , L \} \qquad ( 1 )$$

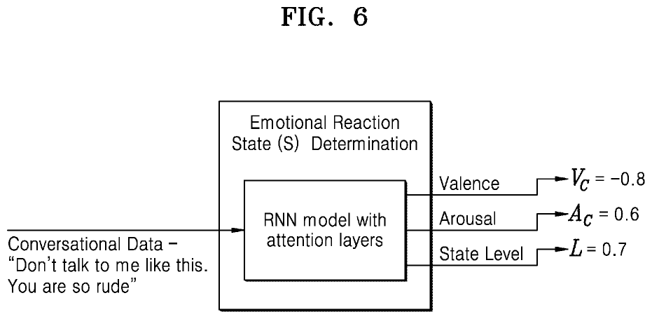

FIG. 6 illustrates an example operation of the emotional reaction state (S) determination for a conversational data, according to an embodiment of the present disclosure. For an exemplary conversation data “Don't talk to me like this. You are so rude”, the Vc is determined as −0.8, Ac is determined as 0.6, and L is determined as 0.7. According to the exemplary embodiment, a negative Vc implies a state of less pleasure and a positive Ac implies a state of proactiveness of the avatars. Accordingly, the emotional reaction state (S) may be determined as a frustrated state.

Referring again to FIGS. 4-5, in operation 403, the emotional reaction state (S) including the emotional valence parameter (Vc), and the emotional arousal parameter (Ac) is determined. The operation 403 corresponds to the operation 503 of FIG. 5.

After the determination of the emotional reaction state (S), the emotional valence parameter (Vc), and the emotional arousal parameter (Ac), at operation 405, the exaggeration level determining module 301-2, determines an exaggeration level (ε) corresponding to the emotional reaction state (S) and the emotion indicators In particular, the exaggeration level (ε) is determined based on each of the emotional reaction state, a probability of the emotional reaction state (L) of the one or more avatars, and the relational data. According to an embodiment, the exaggeration level indicates a measure of extremeness of intensity associated with the emotional reaction state. Further, the measure of the extremeness of intensity is a measure that is required to showcase the reaction of the one or more avatars during the real time conversation.

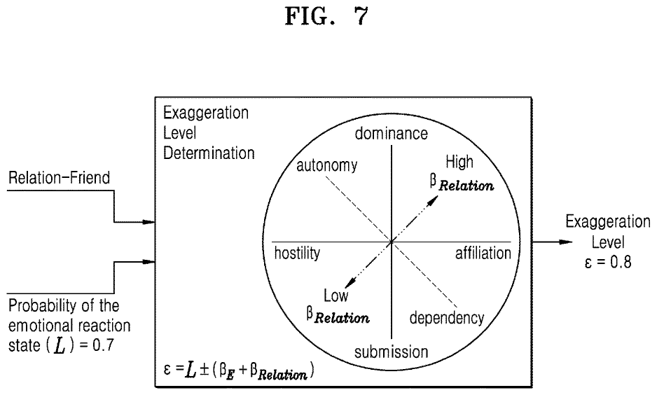

FIG. 7 illustrates an example operation of the exaggeration level determination for a probability of the emotional reaction state (L) and the relation, according to an embodiment of the present disclosure. In general, the exaggeration level is determined by equation 2.

$$ε = L \pm β \qquad ( 2 )$$

Further, the exaggeration factor (β) is a factor of two values i.e., β_{S} and the relational data β_{Relation}. In an embodiment the factor β_{S} maybe a user-inputted or a default setting corresponding to fixed values depending upon the emotional reaction state (S). The factor β_{S} is added to provide some personalization to the reaction of the user corresponding to a given emotional reaction state. Further, the relational data β_{Relation} is a small variation depending upon the relation between the users. In an embodiment, the relational data is determined by a value of autonomy, a value of dominance and a value of affiliation. For example, the value of autonomy is determined by the value of autonomy and dependency of one avatar relative to the other avatar. For example, the value of dominance is determined by the value of dominance and submission of one avatar relative to the other avatar. For example, the value of affiliation is determined by the value of affiliation and hostility of one avatar relative to the other avatar. In an embodiment, a high value of the relational data means a higher autonomy, dominance, and affiliation. For example, a higher value of β_{Relation} means that higher autonomy, dominance and affiliation and otherwise, a lower value is assigned. The exaggeration factor (β) is given by equation 3.

$$β = {β}_{S} + {β}_{Relation} \qquad ( 3 )$$

For the probability of the emotional reaction state (L) as 0.7 and the relation between the one or more avatars as friends, the exaggeration level is determined as 0.8. The exaggeration level is determined for personalizing an intensity level of the emotion depending upon the relation or personalized settings. For example, a friend is assigned a higher β_{Relation} due to a high dominance and autonomy in the relation.

Accordingly, in operation 405, the exaggeration level is determined. The operation 405 corresponds to operation 505 of FIG. 5.

Referring back to FIGS. 3 and 4, the state-data associating module 303 determines emotion indicators (D) with respect to the emotional reaction state based on the emotional valence parameter (Vc), and the emotional arousal parameter (Ac). The emotion indicators indicate the reaction parameters that are likely to be affected with respect to the emotional reaction state. As explained above, the reaction parameters include one or more of the color of the skin of the one or more avatars, the plurality of body attributes of the one or more avatars, the temperature associated with the plurality of body attributes of the one or more avatars, the plurality of symbols with respect to the emotional reaction state, the charge associated with the plurality of body attributes of the one or more avatars, or the gravity of the associated with the plurality of body attributes of the one or more avatars and the like. The emotion indicator (D) may be alternately referred to as reaction data throughout the disclosure.

In an embodiment, the state-data associating module 303 performs a state-data association to associate the emotional reaction state with the emotion indicators. For example, the color, the body attributes, temperature, the gravity, etc. can be associated with the emotion for depicting the exaggerated emotion of the avatars. The state-data associating module 303 utilizes regression methods such as a decision tree or random forest for determining the state-data association. As an example, the reaction emotion “happy” or “shy” can be associated with colors like pink/red. Further, the body attributes like cheeks may be set with the temperature value as 25° C. and the like.

Accordingly, the state-data associating module 303 correlates the reaction parameters with respect to the emotional reaction state based on the emotional valence parameter (Vc) and the emotional arousal parameter (Ac) and determines the emotion indicators based on the result of the correlation. The following paragraphs explain the correlation of the reaction parameters with respect to the emotional reaction state by modeling and training various datasets for a number of emotion indicators such as the color, the body attributes, the temperature, etc.

According to an embodiment, for the state-data association modeling an input features include the predicted Vc and Ac values. The output features include the number of emotion indicator associated with the input features. Thus, the output predicts a number of output features representing a possible value for each of the reaction parameters. A general regression mechanism is used where based on the input Vc and Ac values, the number of associated reaction parameters is predicted. Since the input and output features for this task are not of high dimensions, a decision tree-based regression or random forest can be used thereby keeping the model small in size. In an embodiment, the final outcome of each decision tree is averaged to determine the final output data.

In an embodiment, the model of random forest is required to be trained in order to predict the output. There are a number of datasets present that are utilized for training. As an example, the datasets that can be used for training include a state-color dataset, a state-body part dataset, a state-symbol dataset, a state-temperature association dataset, and the like.

In an embodiment, the state-color dataset relates not only colors but also hue, saturation, and brightness with the Ac and Vc. For a given emotional reaction state with a Vc as V, and Ac as A, it is possible to determine color with respect to the V as {R_{V}, G_{V}, B_{V}} and color w.r.t as {R_{A}, G_{A}, B_{A}}. Further, considering the additive and/or subtractive nature of colors, the color associated with a reaction emotion, E is given by equation 4.

$$\{ {R}_{E} , {G}_{E} , {B}_{E} \} = \{ {R}_{V} + {R}_{A} , {G}_{V} + {G}_{A} , {B}_{V} + {B}_{A} \} \qquad ( 4 )$$

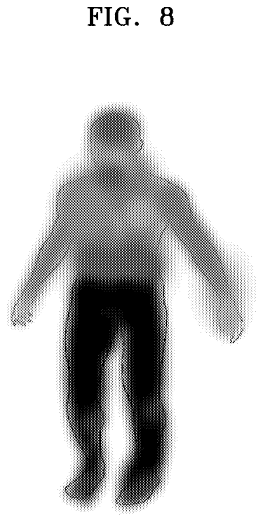

In an embodiment, for the state-body part dataset, both classic and modern models of emotion processing state, the perception of emotion changes reflect changes in skeletomuscular changes along with neuroendocrine and autonomic nervous system. Thus, each of the body attributes may be used to depict the emotion. Thus, different emotions are associated with statistically clearly separable bodily sensation maps (BSMs). The BSMs are hence used to associate a number of body parts, Bₚ, corresponding to the given emotion. Thus, Bₚ is a list of body parts having a high value in the determined BSM. FIG. 8 illustrates an example of BSM corresponding to an anger emotion, according to an embodiment of the present disclosure. FIG. 8 depicts a BSM when the emotion of the avatars corresponds to the anger.

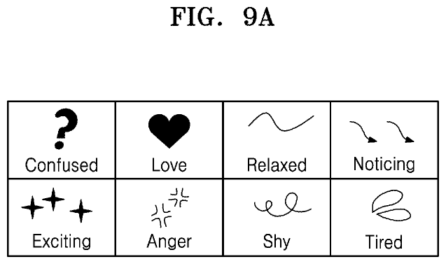

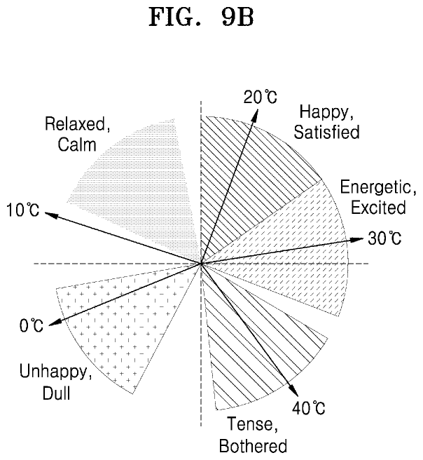

In an embodiment, a given emotional reaction state of the user is associated with an expression symbol that depicts the emotional reaction state. The dataset for state-symbol is a hand-labeled dataset, for assigning expression symbols to the emotional reaction state. FIG. 9A illustrates an example of state-symbol dataset, according to an embodiment of the present disclosure. In an embodiment, the state-symbol includes “Confused”, “Love”, “Relaxed”, “Noticing”, “Excited”, “Anger”, “Shy”, “Tired”. In an embodiment, there may be a one-to-many relation between the state and the symbols. Thus, for each of the emotional reaction state (S), number of symbols that can be selected is given by equation 5.

$${S}_{exp} = A list of expression symbols associated with S \qquad ( 5 )$$

where, the Sₑₓₚ[i] is a symbol from the state-symbol dataset, i<S_{e,TOTAL}.

In a further embodiment, the value of the temperature is used to depict the emotion. As an example, heat maps of emotions with the temperatures ranging from 0° C. to 40° C. can be used to represent the emotions of the avatars. Based on the Ac and Vc the temperature that the emotion can convey is used. As an example, cold is often related to negative valence and low-arousal emotions whereas a hot with a positive-valanced and a high-arousal emotions. Thus, for a given emotion, Temperature, T_{E} maybe determined using an emotion-temperature heat map. FIG. 9B illustrates an example of emotion-temperature association, according to an embodiment of the present disclosure. In an embodiment, an unhappy or dull emotion may be depicted with temperature with 0° C. As an example, the temperature with 0° C. may be depicted with dull colors like purple and the like. Further, emotion with relaxed or clam colors may be depicted with temperature with 10° C. The temperature with 10° C. may be depicted with clam colors like sky blue and the like.

According to an embodiment, based on the above dataset, the training of the dataset is performed using the random forest mechanism. As an example, the training of the dataset involves steps such as bootstrapping to generate multiple subsets of the data to train each decision tree. Further, feature selection is performed by randomly selecting an input feature to determine the split. Further, a recursive Tree-building is used by selecting the best split at each step. The best split at each step during the training step of tree-building is done based on a loss function, such as minimizing a mean squared error given by equation (6):

$${MSE}_{State - Data} = 1 / {n ( {D}_{1 , true} ( S ) - {D}_{1 , pred} ( S ) )}^{2} \qquad ( 6 )$$

where, D_{1,true}(S) is the true value of associated Data D₁ for an input Reaction State S={V_{c}, A_{c}}, D_{1,pred}(S) is the predicted value of associated Data D₁ for an input Reaction State S={V_{c}, A_{c}}. Finally, all the predicted data associated with the emotion reaction State are outputted along such that D₀=S and D₁ to Dₙ, representing the predicted emotion reaction state-data as determined above, where n′ is the total number of emotional reaction state-data.

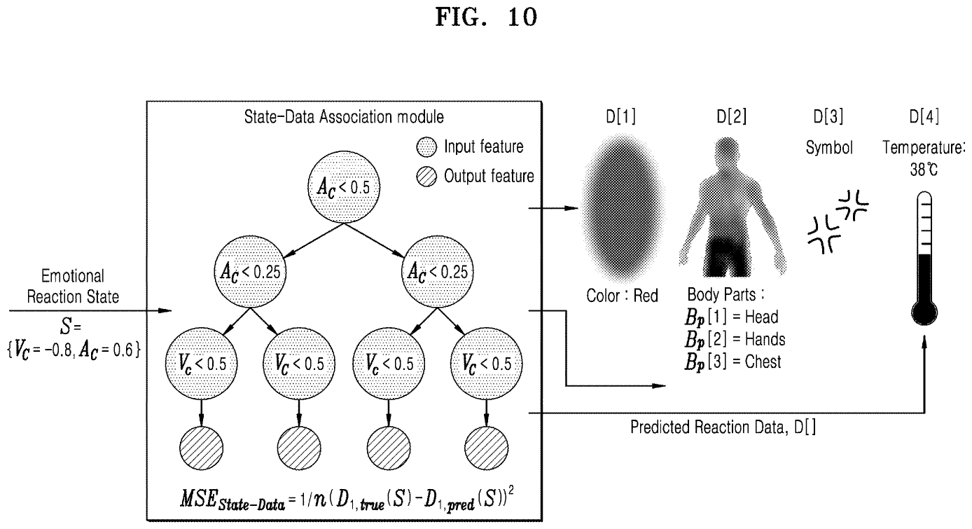

FIG. 10 illustrates an example working of state-data association mechanism, for a sample emotional reaction state, according to an embodiment of the present disclosure. As an example, the emotional reaction state (S) where the Vc is −0.8, and Ac is 0.6 is provided as the input feature to the state data associating module 303. Accordingly, the predicted emotion indicators (reaction data D) are: the color is predicted as red in D[1], the state of the various body parts (Bp) is predicted in D[2], the symbol is predicted in D[3] and the temperature is predicted as D[4].

Accordingly, based on the result of the correlation, the plurality of emotion indicators (reaction data D) with respect to the emotional reaction state is determined at operation 407. Further, the operation 407 corresponds to the operation 505 of FIG. 5.

Referring back to FIGS. 3 and 4, the emotion indicator and the exaggeration level is then provided as an input to the adaptive space configuring module 307. Accordingly, the adaptive Space Configuring Module 307, at operation 409 of FIG. 4, determines space configuration values (S_{conf}) for each space point each of the one or more avatars. In an embodiment, the space configuration values (S_{conf}) is determined based on configuration of space parameters for each space point among a plurality of space points in the virtual space with respect to the emotion indicators (D) and the exaggeration level (F). The following paragraphs will explain the space parameters.

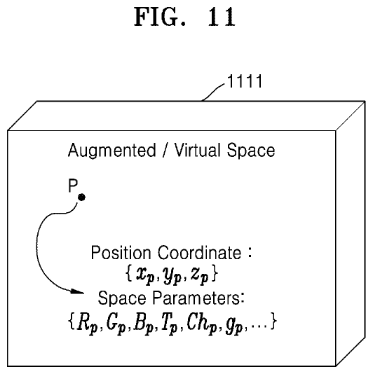

FIG. 11 illustrates an example of a single space point in the virtual space, according to an embodiment of the present disclosure. According to an embodiment, every point in the virtual space 1111 has i) position Coordinates and ii) space Parameters as depicted in FIG. 11. Thus, from FIG. 11, the space point P has position Coordinates as {x_{P}, y_{P}, z_{P}} and space parameters as R_{P}, G_{P}, B_{P}, Tₚ, Chₚ, gₚ, . . . }. In an embodiment, the space parameters are the values of elements of space at the given space point. The N′ number of elements of space is defined as follows:
R_{P}, G_{P}, B_{P} are pixel values that is assigned to the point P and represent the red, green, and blue values, (0 to 255).
Tₚ is the temperature assigned at the given space point (0° C. to 40° C.).
Chₚ is the charge assigned at the given space point. In an embodiment, the Chₚ may have three values such as a positive charge (+x), a neutral charge (0), and a negative charge (−x) where x>1, a higher x representing a strongly charged point.
gₚ is the gravity assigned to the space points. In an embodiment, the gₚ maybe configured accordingly to exaggerate.

In an embodiment, there may be more space parameters assigned to the space such as a hue, saturation, brightness, wind speed, etc. N′≥1. Thus, to summarize the space parameters include at least pixel values, the temperature associated with each space point, the charge associated with each space point, and the gravity associated with each space point. Further, each pixel represents one of a color among a RGB color space. In an embodiment, for determining the space configuration values (S_{conf}), the adaptive space configuring module 307 configures the space parameters for each space point among the plurality of space points with respect to the plurality of emotion indicators and the exaggeration level. In an embodiment, for configuring space parameters, the space subset configuration module 307-1 of the adaptive space configuring module 307 determines a space subset configuration at operation 411, and the space point configuration module 307-2 at operation 413 determines a space point configuration in the virtual space surrounding to the one or more avatars. The operation 411 and 413 will be explained in the forthcoming paragraphs.

According to an embodiment, the space subset configuration is a configuration of a space subset in the virtual space, where the space subset corresponds to a space surrounding to the one or more avatars. Thus, in order to make the appearance of the space configuration more realistic and expressive, the space is first assigned a ‘Space—Subset Value’ depending upon the reaction data (emotion indicator) such as the Body Parts, B.

According to an embodiment, the space subset configuration module 307-1 for determining the space subset configuration in the virtual space, at first divides the virtual space into a plurality of subsets. Each subset is represented as Si where 1≤i≤K, representing that K subset of the space may be formed. Thereafter, the space subset configuration module 307-1 assigns a space-subset value (V_{space}) to each of the plurality of subsets based on a relation between a corresponding subset of the plurality of subsets, and the emotion indicators. As an example, the relation includes a Euclidean distance between a corresponding subset of the plurality of subsets and a corresponding body attribute of the plurality of body attributes, a direction of the corresponding subset of the plurality of subsets with respect to the corresponding body attribute of the plurality of the body attributes of the each of the one or more avatars. Further, the assigned space-subset value is an extra-exaggeration factor or extra-factor or X-Factor that is included in the corresponding subset of the plurality of subsets. Accordingly, the space subset configuration is determined based on the assigned space-subset value.

In an embodiment, mathematically the space-subset value (V_{space}) is given by equation 7.

$${V}_{space} = \{ {v}_{S 1} , {v}_{S 2} , … {v}_{Sk} \} \qquad ( 7 )$$

where, S1, S2, . . . Sk are the K subsets of the virtual space and v_{Si} is the space-wise value assigned to the subset Si. Each of space-wise values, v_{Si} is the ‘X-Factor’ corresponding to each of the subsets of the space. The X-Factor′ signifies the ‘extra-factor’ that needs to be included for a given subset Si for a given element of space. The significance of the values can be envisaged from the following equation 8.

$$\{ \begin{matrix}0 < {v}_{Si} \leq 1 ⇒ supression \\ {v}_{Si} > 1 ⇒ amplifiation\end{matrix} of space parameters \qquad ( 8 )$$

In an embodiment, the v_{Si} is dependent on the number of the reaction data, the reaction data D, distance, and direction of the Subset Sᵢ from the avatar. In general terms, the Space-subset value is given by equation 9.

$${v}_{Si} = {f}_{1} ( {D}_{1} , {D}_{2} , … {D}_{j} , {dis}_{avatar} , {dir}_{avatar} ) \qquad ( 9 )$$

An instance of ƒ₁ where the reaction data such as body part is used, the determination of the value v_{Si} is performed based on the following equation 10.

$$[ \begin{matrix}{v}_{S 1} \\ {v}_{S 2} \\ ⋮ \\ {v}_{Sk}\end{matrix} ] = [ \begin{matrix}1 / {dis}_{S 1} 1 / {dir}_{S 2} \\ 1 / {dis}_{S 2} 1 / {dir}_{S 2} \\ ⋮ \\ 1 / {dis}_{Sk} 1 / {dir}_{Sk}\end{matrix} ] \cdot [ \begin{matrix}w 1 \\ w 2\end{matrix} ] \qquad ( 10 )$$

where, dis_{Si}=Euclidean distance of subset Si from the body part determined as a step of emotion reaction state-Data Association,
dir_{Si}=Direction of a subset Si w.r.t the body part (significant in case of 3D space),
w1, w2 are the weights assigned to w1 and w2.

The inverse relation with dis_{Si} and dir_{Si} signify that the subset lying close to the related body part is assigned a higher value. In an embodiment, the dis_{Si} for a given list of body parts B_{P}[ ] is calculated based on equation 11.

$${dis}_{Si} = {\sum }_{j = 1}^{n} {w}_{j}^{′} * \{ {( {Si}_{x} - {{B}_{P} [ j ]}_{x} )}^{2} + {( {Si}_{y} - {{B}_{P} [ j ]}_{y} )}^{2} + {( {Si}_{z} - {{B}_{P} [ j ]}_{z} )}^{2} \} \qquad ( 11 )$$

where, Siₓ, Si_{y}, Si_{z} are the position coordinates of the Subset Si (centroid or coordinate of central space point);
B_{P}[j] represent the j^{th} body part determined using BSM, such that B_{P} [1] is the body part having highest score while b[n′] having the least score in the BSM,
B_{P}[j]ₓ, B_{P}[j]_{y}, B_{P}[j]_{z} are the position coordinates of the j^{th} body part (or the Subset lying closest to the body part),

$${w}_{j}^{′}$$

is the weight assigned to the Euclidean distance between space subset Si and j^{th} body part B_{P}[j], such that

$${w}_{j}^{′} > {w}_{j + 1}^{′} .$$

In an embodiment, the dir_{Si} for a given list of Body parts B_{P} [ ] is significant mostly for the 3D augmented/virtual space where the distance alone is not able to distinctly identify the subset. As an instance in such cases, a subset falling in the direction of the user's facing might have a higher value of dir_{Si}. Thus, the determination of the space subset configuration and the space parameters corresponds to the operation 411 of FIG. 4. The forthcoming paragraphs explain determining the space point configuration via operation 413 of FIG. 3.

In an embodiment, the space point configuration module 307-2 configures each point in the space by assigning the space parameter value. In an embodiment, the space point configuration module 307-2 determines the space point configuration (Vpi) based on the plurality of emotion indicators (reaction data D), a space-subset value to each of the plurality of subsets, and the exaggeration level. According to an embodiment, the space point configuration is determined by assigning the plurality of space parameters to each space point based on the reaction data and then determining the space point configuration based on the assignment. Thus, the space point configuration is exaggerated by the space subset value.

For example, consider that Vₚₒᵢₙₜ represents space-point values and is defined by equation 12.

$${V}_{point} = \{ {v}_{p 1} , {v}_{p 2} , … {v}_{pn} \} \qquad ( 12 )$$

where, p1, p2, . . . pn are the points in the virtual space,
vₚᵢ is the space parameter value at point pi.
For instance,

$${v}_{pi} = \{ {R}_{pi} , {G}_{pi} , {B}_{pi} , {Ch}_{pi} , {T}_{pi} , {g}_{pi} \} \qquad ( 13 )$$

According to an embodiment, the v_{Pi} is dependent on the number of reaction data, D[ ], the space-subset value, v_{Sj} and the exaggeration level, ε. In general terms, the space-subset value is given by equation 14.

$${v}_{pi} = {f}_{2} ( {D}_{1} , {D}_{2} , … {D}_{j} , ε , {v}_{S j} ) given pi ϵ Subset Sj \qquad ( 14 )$$

As an example, for function ƒ₂, the determination of the value v_{Pi} is based on equation 15.

$$( \begin{matrix}{v}_{p 1} \\ {v}_{p 2} \\ ⋮ \\ {v}_{pn}\end{matrix} ) = ( \begin{matrix}{R}_{p 1} & {G}_{p 1} & {B}_{p 1} & {Ch}_{p 1} & {T}_{p 1} & {g}_{p 1} \\ {R}_{p 2} & {G}_{p 2} & {B}_{p 2} & {Ch}_{p 2} & {T}_{p 2} & {g}_{p 2} \\ ⋮ & ⋮ & ⋮ & ⋮ & ⋮ & ⋮ \\ {R}_{pn} & {G}_{pn} & {B}_{pn} & {Ch}_{pn} & {T}_{pn} & {g}_{pn}\end{matrix} ) = ( \begin{matrix}{w}_{11} & {w}_{12} & {w}_{13} & {w}_{14} & {w}_{15} & {w}_{16} \\ {w}_{21} & {w}_{22} & {w}_{23} & {w}_{24} & {w}_{25} & {w}_{26} \\ ⋮ & ⋮ & ⋮ & ⋮ & ⋮ & ⋮ \\ {w}_{n 1} & {w}_{n 2} & {w}_{n 3} & {w}_{n 4} & {w}_{n 5} & {w}_{n6}\end{matrix} ) ( \begin{matrix}{D}_{1} & 0 & 0 & 0 & 0 & 0 \\ 0 & {D}_{2} & 0 & 0 & 0 & 0 \\ 0 & 0 & {D}_{3} & 0 & 0 & 0 \\ 0 & 0 & 0 & {D}_{4} & 0 & 0 \\ 0 & 0 & 0 & 0 & {D}_{5} & 0 \\ 0 & 0 & 0 & 0 & 0 & {D}_{6}\end{matrix} ) \times ε \qquad ( l5 )$$

Where, D₁, D₂, D₃ are the color associated with the emotion, R_{E}, G_{E}, B_{E}
D₄ is the charge associated with the emotion, Ch_{E}
D_{S} is the temperature associated with the emotion, T_{E}
D₆ is the gravity associated with the emotion, g_{E}
w_{xy} is the weight, which is a factor of v_{Sj} such that

$${w}_{xy} = {v}_{Sj} * {w}_{xy}^{′} \qquad ( 16 )$$

given, Point Pₓ∈Space Subset Sj and

$${w}_{xy}^{′} \geq 0$$

ε is the exaggeration level.

In a further embodiment, the given instance of ƒ₂, may additionally handles placing the input symbols at space points having a high space-subset value. i.e., position Sₑₓₚ[j] at space-point pⱼ and Sₑₓₚ [j+1] at space-point pⱼ₊₁ such that v_{Sk}>v_{Sk+1}, given pⱼ∈Space subset Sk and pⱼ₊₁∈Space subset Sk+1. Thus, the space configuration values, S_{conf}=V_{Point} is outputted. Thus, the determination of the space point configuration corresponds to operation 413.

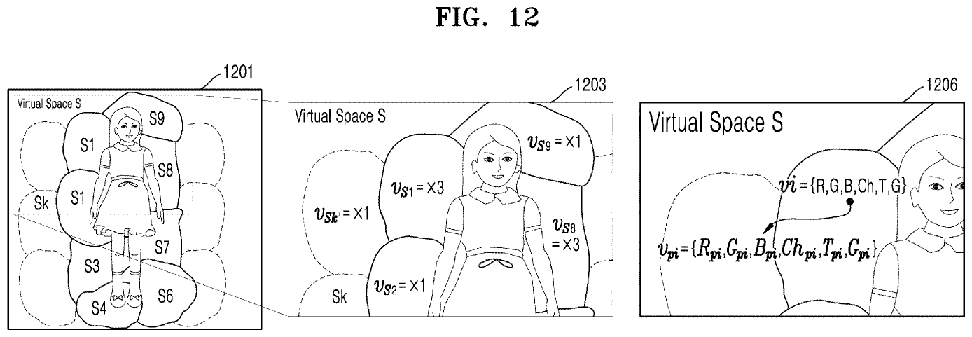

FIG. 12 illustrates examples of an adaptive space configuration, according to an embodiment of the present disclosure. Block 1201 illustrates the virtual space having a plurality of subsets. Further, at block 1203 as depicted each of the space subset values i.e. Vₛ₁, Vₛ₂, Vₛ₉, Vₛ₈ Vₛₖ are assigned with X-factor X3, X1, X1, X3, X1 respectively. X3 implies X factor of 3 times and X1 implies X factor of 1 time. Further, at block 1205, as depicted space point value vₚᵢ at point Pi is (Rpi, Gpi, Chpi, Tpi, Gpi).

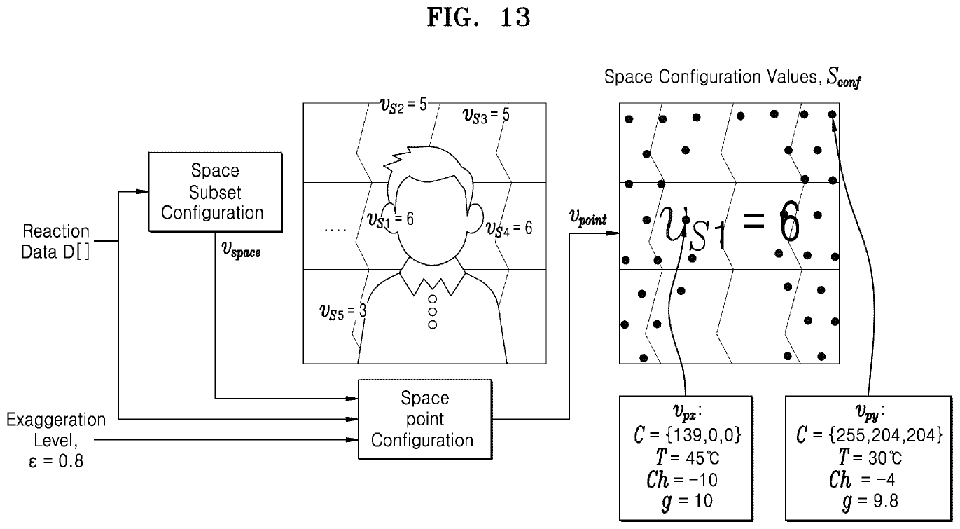

FIG. 13 illustrates an example working of space subset configuration and space point configuration, according to an embodiment of the present disclosure. In an embodiment, the reaction data and exaggeration level space subset configuration is determined. In an embodiment, space subset S1, S2, S3, S4 are given a higher value as they are closer to the body part head and point px which lies inside S1 is assigned exaggerated values of elements of space as compared to point py.

Further, operation 411 and operation 413 collectively determine the space configuration values, S_{conf} of operation 409 as explained above. Further, the operation 409 corresponds to operation 507 of FIG. 5.

In an embodiment, the space configuration values (S_{conf}) is provided as an input to the avatar's final configuration module 305-2 of the space reaction determining module 305. According to an embodiment, the space reaction determining module 305 at operation 417 determines final configuration values (A_{ƒ, conf}) corresponding to the each of one or more avatars based on a correlation between initial configuration values assigned to the each of one or more avatars and the space configuration values (S_{conf}) corresponding to each of the plurality of avatars.

In an embodiment, at operation 415, the avatar's initial Configuration module 305-1 receives the user input 414. As an example, the user input includes at least avatar's input parameters corresponding to each of the one or more avatars. As an example, the avatar's input parameters may include parameters such as avatar's is wearing a winter cloth, avatar's body temperature is high and the like that may be provided by the user. Thereafter, the avatar's initial Configuration module 305-1 determines initial configuration values (A_{i, conf}) corresponding to the each of one or more avatars based on an assignment of configuration values to each body point among a plurality of body points in accordance with the user input i.e. avatar's input parameters. In an embodiment, the initial configuration values are assigned based on predefined values defined with respect to at least the avatar's input parameters, the user input, and normal body values. In an embodiment, the plurality of body points represents a plurality of body elements of the one or more avatars that are used to represent a state of body of the one or more avatars. Further, the state of the body includes at least the temperature, the charge, the skin color, a hair color, and a sweat of the one or more avatars.

In an embodiment, consider that bi be the avatar's body points, for i≤m. Thus, the Avatar's Initial Configuration values, A_{i, conf}, is given by equation 16:

$${A}_{i , conf} = \{ {v}_{i , b 1} , {v}_{i , b 2} , … {v}_{i , bm} \} \qquad ( 16 )$$

where, v_{i,bi} is initial configuration values assigned to the body point bi.

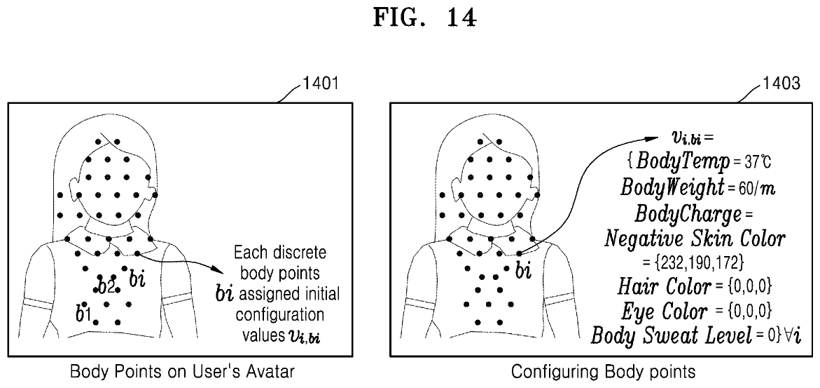

FIG. 14 illustrates an example of body points on the user's avatar and configuring body points, according to an embodiment of the present disclosure. In an embodiment, block 1401, each discrete body points bi assigned initial configuration values v_{i,bi}. Further, the configuration values consist of values corresponding to the elements of the body. The elements of the body are the elements that may be used to represent the state of the body of the avatar. As an example, the configuration values includes one or more of Body-Temperature, Body-Weight, Body-Charge, Skin Color, Hair Color, Eye color, Body Sweat Level, etc. It is important to note here that the body elements may be a super-set of space-elements defined earlier.

In an embodiment, the v_{i,bi} is the initial value of each of the one or more body elements assigned to the body point bi, given by equation (17):

$$\begin{matrix}{v}_{i , bi} = {\{ Body Elements Values \}}_{i , bi} \\ = {\{ Temp , Weight , Charge , Skin Color , Hair Color , Sweat \}}_{i , bi}\end{matrix} \qquad ( 17 )$$

Accordingly, the initial avatar's configuration values are at least predetermined (pre-defined based on the normal body values), depending on the user's avatar input (based on the avatar's parameters), and input by the user. An example of the initial configuration based on predetermined values is shown in block 1403. The values may be modified based on the avatar's parameters. As an example, the avatar wearing winter clothes may have a higher body temperature.

In an embodiment, at operation 417, the avatar's final configuration module 305-2 receives the initial avatar's configuration values. In an embodiment, the initial configuration is then provided as an input to the avatar's final configuration module 305-2. Accordingly, the avatar's final configuration module 305-2 determines the correlation between the initial configuration values corresponding to the each of one or more avatars and the space configuration values (S_{conf}) corresponding to each of the one or more avatars. Thus, based on the correlation between the initial configuration values and the space configuration values (S_{conf}) the avatar's final configuration module 305-2 determines the final configuration values corresponding to each of the one or more avatars.

In an embodiment, the avatar's final configuration, A_{ƒ, conf} represent the values of final elements of the body of the avatar, determined as a result of reaction determination between the determined space configurations, S_{conf} and the Avatar's initial configuration, A_{i, conf}. Mathematically, A_{ƒ, conf} is defined by equation 18.

$${A}_{f , conf} = {f}_{3} ( {A}_{i , conf} , {S}_{conf} ) {v}_{f , bi} = {f}_{3} ( {v}_{i , bi} , {v}_{pj} ) \qquad ( 19 )$$

where, v_{i,bi} is the Avatar's initial configuration value at body point bi,
   v_{ƒ,bi} is the Avatar's final configuration value at body point bi,
   vₚⱼ is the Space configuration value at space point pj such that pj is the nearest space point to the body point bi,
   ƒ₃ is a function catering to the reaction between space and avatar.

In an example embodiment for ƒ₃, the determination of the value v_{ƒ,bi} is based on equation 20.

$${v}_{f , bi} = [ B {1}_{f , bi} B {2}_{f , bi} … {BL}_{f , bi} ] = \text{} [ B {1}_{i , bi} B {2}_{i , bi} … {BL}_{i , bi} ] + [ {w}_{i 1} {w}_{i 2} {w}_{i 3} … {w}_{i {N}^{′}} ] \text{} [ \begin{matrix}S {1}_{1 , {p}_{j}} & … & S {1}_{L , {p}_{j}} \\ ⋮ & ⋱ & ⋮ \\ {SN}_{1 , {p}_{j}}^{′} & … & {SN}_{L , {p}_{j}}^{′}\end{matrix} ] \qquad ( 20 )$$

where,
   B1, B2, . . . BL are the L elements of the body at body point bᵢ,
   S1, S2, . . . SN′ are the N′ elements of the space at space point pⱼ,
   pⱼ is the closest space point to the body point bᵢ
   w_{xy} are the weights assigned to Sₓ corresponding to B_{y}

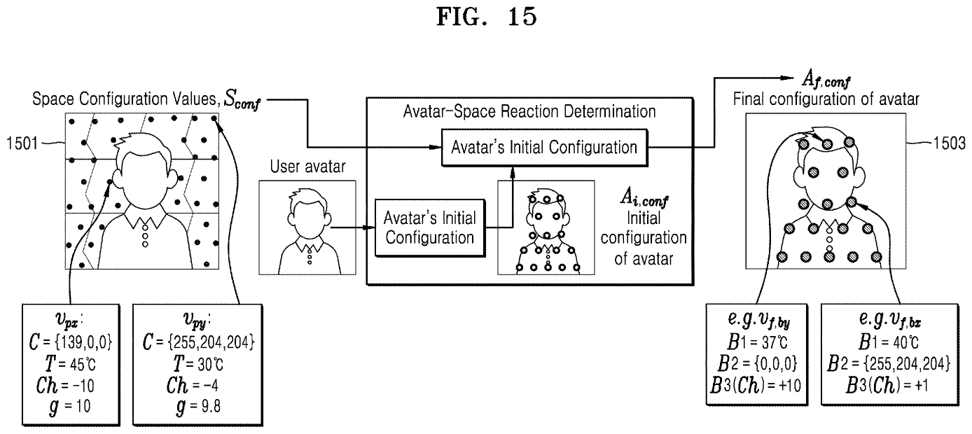

FIG. 15 illustrates a working of avatar-space reaction determination, according to an embodiment of the present disclosure. Given a space configuration at block 1501, the final configuration of the avatar for v_{ƒ,by} and v_{ƒ,bx} are given as below:

$${v}_{f , by} : B 1 = 37 ° C . , B 2 = \{ 0 , 0 , 0 \} , B 3 ( Ch ) = + 10. \\ {v}_{f , bx} : B 1 = 40 ° C . , B 2 = \{ 255 , 204 , 204 \} , B 3 ( Ch ) = + 1. \qquad ( 21 )$$

Accordingly, the determination of the final configuration corresponds to the operation 509 of FIG. 5.

According to some embodiments, the determined context and the reaction data are used to determine the avatar's configuration. According to an embodiment, the avatar's initial configuration is known, and the reaction data is used to determine a final avatar configuration. Thereafter, the final avatar's configuration is then used to configure the surrounding space of the avatar using reaction equations.

According to an embodiment, based on the determination of the final configuration, the avatar and space simulator 313 simulates the one or more avatars exaggerating the reaction. In an embodiment, the determined final avatar's configuration values include values for the elements of body such as—Body-Temperature, Body-Weight, Body-Charge, Skin Color, Hair Color, Eye color, Body Sweat Level, etc. The determined space configuration values include values for the elements of space such as space color, space temperature, space gravity, space charge, etc.

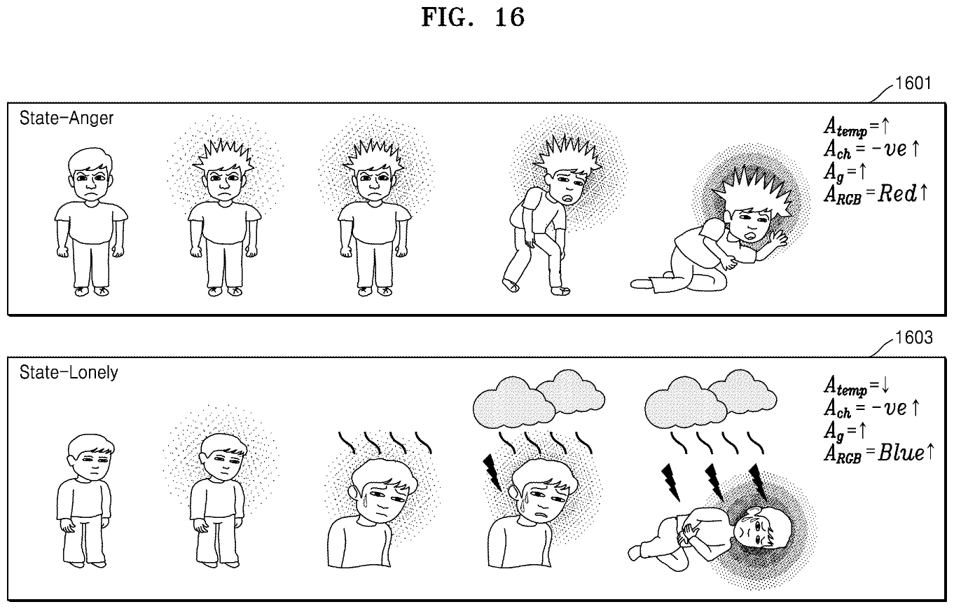

In an embodiment, at operation 419, the avatar and space simulator 313 simulates the exaggerated one or more avatars in the virtual space and renders the simulated exaggerated the one or more avatars in the virtual space. Accordingly, the simulating the one or more avatars exaggerating the reaction corresponds to the operation 511 of FIG. 5. Thus, the space configuration values and the final avatar's configuration values are utilized to render an avatar and also the space accordingly depending upon the configuration values. As an example, the skin color of an avatar may be changed based on the input ‘Skin-Color’; an animation of flying may be added based on the input ‘Body-weight’ and ‘Space-gravity values’; an animation of burning may be added depending upon the ‘Body Temperature’ and ‘Space-Temperature’, etc. FIG. 16 illustrates an example of avatar exaggeration for various states, according to an embodiment of the present disclosure. The example scenario 1601 illustrates an exaggeration of the avatar in a state of anger. In an embodiment, with increasing exaggeration level for the exaggeration of the avatar in a state of anger, the avatar's configuration values(A_{RGB}, A_{Ch}, A_{g}, A_{T}) are changed. In an embodiment, with increasing exaggeration level for the exaggeration of the avatar in a state of anger, A_{RGB}(blue), A_{Ch}, A_{g} and A_{T} are increased. Further, example scenario 1603 illustrates an exaggeration of the avatar in a state of loneliness. In an embodiment, with increasing exaggeration level for the exaggeration of the avatar in a state of loneliness, the avatar's configuration values(A_{RGB},A_{Ch},A_{g},A_{T}) are changed. In an embodiment, with increasing exaggeration level for the exaggeration of the avatar in a state of loneliness, A_{RGB}(blue), A_{Ch} and A_{g} are increased, A_{T} is decreased.

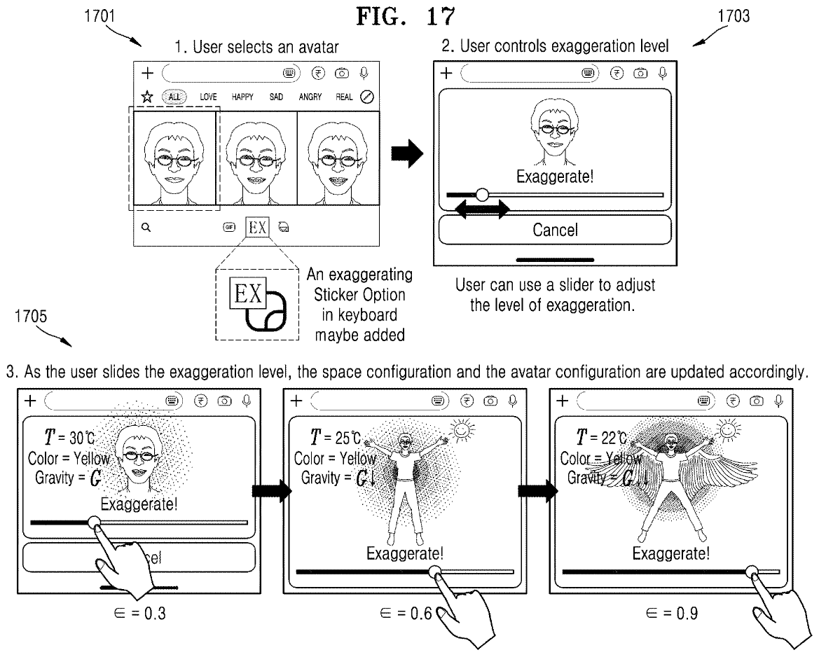

FIG. 17 illustrates an example scenario of intelligently exaggerate avatar's state while chatting, according to an embodiment of the present disclosure. At block 1701, the user may select an avatar via an exaggerating sticker option on a keyboard. Thereafter, at block 1703 the user can use a slider to adjust the level of exaggeration. This allows more freedom of control. Thereafter, at block 1705, as depicted, as the user slides the exaggeration level, the space configuration, and the avatar configuration are updated accordingly.

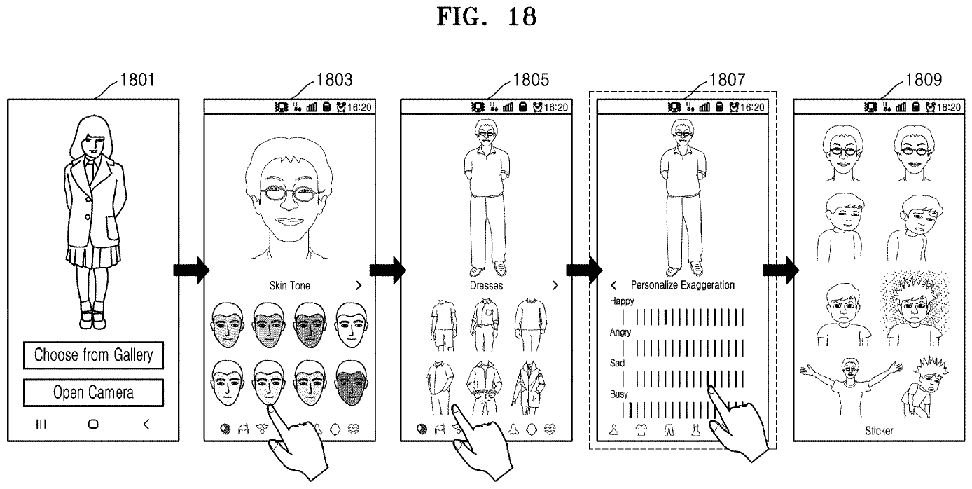

FIG. 18 illustrates an example scenario of creating various exaggerated avatars based on user's selection, according to an embodiment of the present disclosure. At block 1801 the user may select gallery or open a camera for creating avatars. Thereafter, at block 1803, the user may select a skin tone, then at block 1805, the user may select dress. At block 1807, the user may perform personalize exaggeration by using happy, angry, sad or busy emotional state. At block 1807, further provides selection of an exaggeration level. For example, level of happiness, sadness, anger, and the like. Accordingly, at block 1809, various exaggerated avatars are created based on the disclosed methodology.

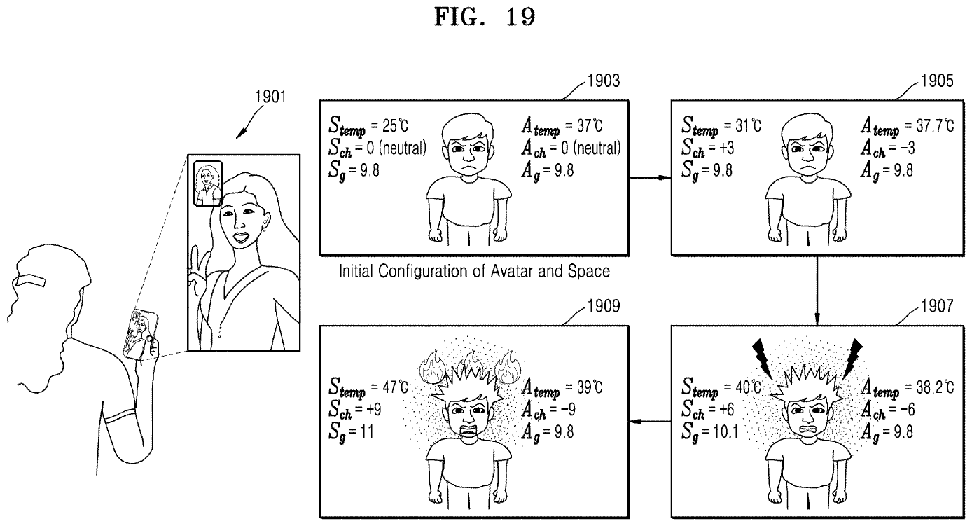

FIG. 19 illustrates an example scenario of creating and exaggerating avatars in real-time during video calling, according to an embodiment of the present disclosure. According to an embodiment, while video calling in AR/VR as shown in the block 1901, avatar's reaction can be shown on television (TV) as the conversation proceeds. Initially, at block 1903 an avatar with initial configuration and initial space configuration is shown. Now, as the user starts getting angry, its avatar starts to change as per the space. In particular, the avatar's configuration and their reaction start to change based on exaggeration level ε7 from the block 1905. In an embodiment, at block 1907 the temperature, charge, gravity, etc. are increasing with the increasing exaggeration level. Furthermore, with increasing anger, exaggeration level is increasing due to which avatar's state is getting changed as the function of avatar's configuration and space configuration reaction as depicted in the block 1909. Thus, as the conversation proceeds, the avatar's state keep changing depending upon the exaggeration level.

According to a further example embodiment, the disclosed methodology may be implemented during a real time photoshoot or video shoot. Consider a situation where the user while clicking photos or making vlogs the user can use this feature to exaggerate user's state. This will make the after-editing part easy for the users.

According to yet further example embodiment, during a virtual meeting, the system may detect the avatars expression and exaggerate its state. In an example scenario consider that, the user is seems to be confused. Therefore, the system may detect this and exaggerate its state to more confused to make the presenter notice it easily. Accordingly, using state exaggeration, avatar's state will be exaggerated so that people who are not able to express or interact with people in meetings or online classes can be recognized by the presenter so that topic can be made clear.

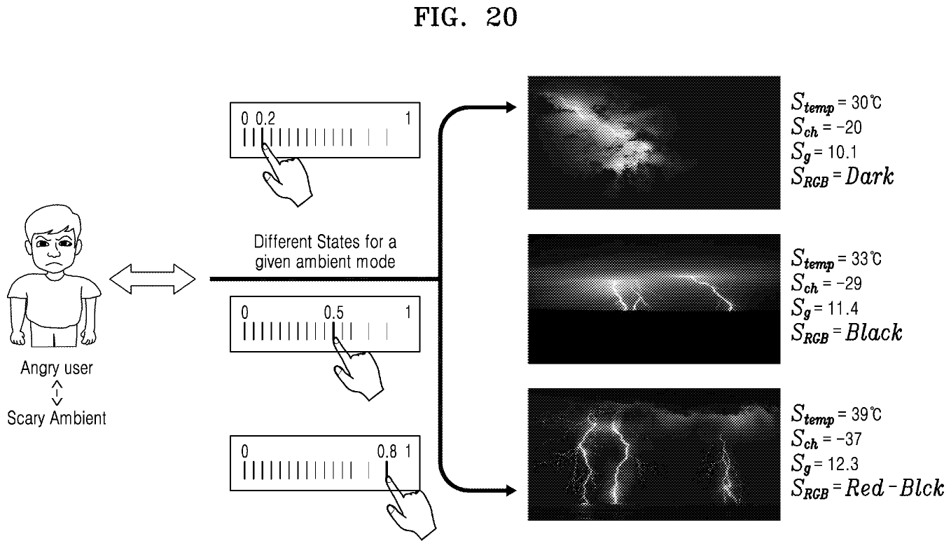

According to yet an example embodiment, the disclosed methodology may be used to exaggerate dynamic ambient mode. According to an example embodiment, based on the user's mood or context, an ambient picture on the TV can be depicted. The user maybe be able to adjust a level of exaggeration for the ambience. A level controls the elements of space of the ambience in the ambient mode of the TV It will correspondingly simulate the ambience based on the adjusted space elements. FIG. 20 depicts an example of different states for a given ambient mode, according to an embodiment of the present disclosure.

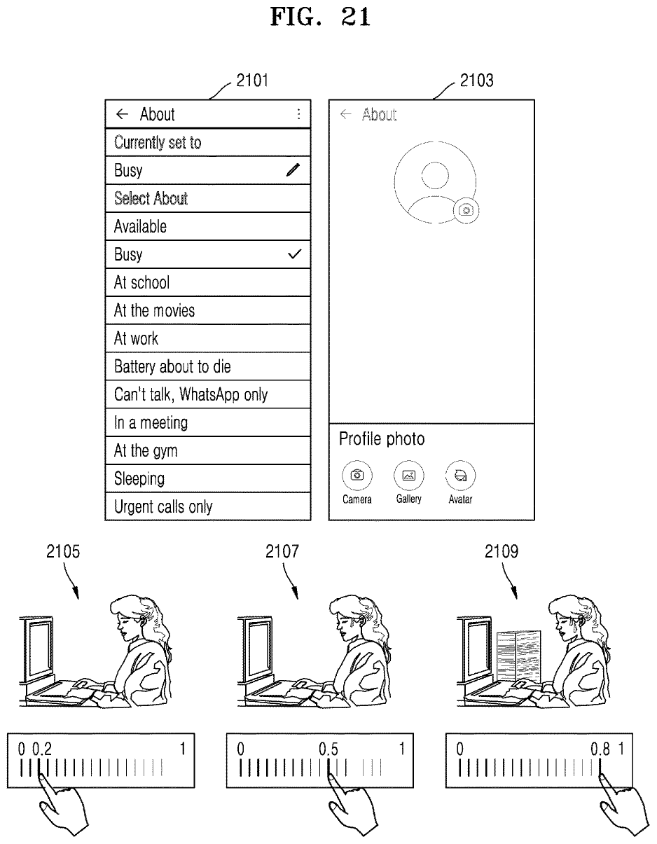

FIG. 21 illustrates an example of exaggerating the social media status of the avatar, according to an example embodiment of the present disclosure. According to an example embodiment, consider that user want to apply status in the social media as busy at block 2101. At block 2103, as the user will select the avatar to apply on profile picture. The system will suggest profile picture based on status with different exaggeration level. As shown in blocks 2105-2109, the user can select and exaggerate its profile picture's avatar using exaggeration level. For different exaggeration values, different configuration values of avatar are determined. With different avatar's configuration, different profile pictures are suggested.

Accordingly, the disclosed methodology provides an enhanced user experience in the virtual environment.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to an embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

In an embodiment, the graphical representations include one or more avatars. In an embodiment the conversational data includes at least text data, audio data, or video data. In an embodiment the plurality of parameters associated with the emotional reaction state includes an emotional valence parameter, an emotional arousal parameter, and a probability of the emotional reaction state of the one or more graphical representations. In an embodiment the method comprises performing the contextual analysis of the conversational data and the relational data and determining the plurality of parameters associated with the emotional reaction state based on the contextual analysis.

In an embodiment, the emotional reaction state indicates a reaction of the one or more graphical representations in response to the conversational data. In an embodiment, the emotional valence parameter indicates a measure of pleasure of the one or more graphical representations. In an embodiment, the emotional arousal parameter indicates a physiological state of the one or more graphical representations. In an embodiment, the physiological state of the one or more graphical representations indicates one of a proactive or inactive state of the one or more graphical representations.

In an embodiment, the relational data is obtained based on at least one of a user input, historical data, or a user profile data. In an embodiment, the exaggeration level is determined based on each of the emotional reaction state, the probability of the emotional reaction state of the one or more graphical representations, and the relational data. In an embodiment, the exaggeration level indicates a measure of extremeness of intensity associated with the emotional reaction state. In an embodiment, the measure of extremeness of intensity is a measure that is required to showcase a reaction of the one or more graphical representations during the conversation.

In an embodiment, the plurality of emotion indicators with respect to the emotional reaction state is determined based on the emotional valence parameter and the emotional arousal parameter. In an embodiment, the plurality of emotion indicators indicates a plurality of reaction parameters that are likely to be affected with respect to the emotional reaction state. In an embodiment, the plurality of reaction parameters includes one or more of a color of a skin of the one of more graphical representations, a plurality of body attributes of the one of more graphical representations, a temperature associated with the plurality of body attributes of the one of more graphical representations, a plurality of symbols with respect to the emotional reaction state, a charge associated with the plurality of body attributes of the one of more graphical representations, or a gravity of the associated with the plurality of body attributes of the one of more graphical representations

In an embodiment, the method comprises correlating the plurality of reaction parameters with respect to the emotional reaction state based on the emotional valence parameter and the emotional arousal parameter and determining the plurality of emotion indicators with respect to the emotional reaction state based on a result of the correlation.

In an embodiment, determining the plurality of space configuration values comprises configuring the plurality of space parameters for each space point among the plurality of space points with respect to the plurality of emotion indicators and the exaggeration level. In an embodiment, the plurality of space parameters includes at least a plurality of pixel values, a temperature associated with each space point, a charge associated with each space point, and a gravity associated with each space point. In an embodiment, each of the plurality of pixel values represents one of a color among a RGB color space.

In an embodiment, configuring the plurality of space parameters comprises determining a space subset configuration and a space point configuration in the virtual space surrounding to the one or more graphical representations.

In an embodiment, the space point configuration is determined based on the plurality of emotion indicators, a space-subset value to each of the plurality of subsets, and the exaggeration level.

In an embodiment, wherein the space subset configuration is a configuration of space subset in the virtual space, wherein the space subset corresponds to a space surrounding to the one or more graphical representations. In an embodiment, determining the space subset configuration in the virtual space comprises dividing the virtual space into a plurality of subsets, assigning a space-subset value to each of the plurality of subsets based on a relation between a corresponding subset of the plurality of subsets, and the plurality of emotion indicators, wherein the relation includes an Euclidean distance between a corresponding subset of the plurality of subsets and a corresponding body attribute of the plurality of body attributes, a direction of the corresponding subset of the plurality of subsets with respect to the corresponding body attribute of the plurality of the body attributes of the each of the one or more graphical representations, wherein the assigned space-subset value is an extra-exaggeration factor that is included in the corresponding subset of the plurality of subsets and determining the space subset configuration in the virtual space based on the assigned space-subset value.

In an embodiment, determining the final configuration values corresponding to each of the one or more graphical representations comprises: receiving a user input including at least avatar's input parameters corresponding to each of the one or more graphical representations, determining the initial configuration values corresponding to the each of one or more graphical representations based on an assignment of configuration values to each body point among a plurality of body points in accordance with the user input, determining the correlation between the initial configuration values corresponding to the each of one or more graphical representations and the space configuration values corresponding to each of the one or more graphical representations and determining the final configuration values corresponding to each of the one or more graphical representations based on the correlation between the initial configuration values and the space configuration values.

In an embodiment, the initial configuration values are assigned based on a predefined values defined with respect to at least the avatar's input parameters, the user input, and a normal body values. In an embodiment, the plurality of body points represents a plurality of body elements of the one or more graphical representations that are used to represent a state of body of the one or more graphical representations. In an embodiment, the state of the body includes at least a temperature, charge, skin color, hair color, sweat of the one or more graphical representations.

In an embodiment, determining the space point configuration comprises: assigning the plurality of space parameters to each space point based on the reaction data and determining the space point configuration based on the assignment, wherein the space point configuration is exaggerated by the space subset value.

In an embodiment, a computing system for exaggeration of a reaction of one or more avatars in a virtual environment, the computing system includes one or more processors configured to: obtain conversational data corresponding to real time conversation between two or more avatars in a virtual space of the virtual environment and relational data associated with a relation between the one or more avatars, determine an emotional reaction state associated with each of the one or more avatars based on a contextual analysis of the conversational data and the relational data, determine, based on a plurality of parameters associated with the emotional reaction state, an exaggeration level corresponding to the emotional reaction state and a plurality of emotion indicators with respect to the emotional reaction state, determine, for each of the one or more avatars based on configuration of a plurality of space parameters for each space point among a plurality of space points in the virtual space with respect to the plurality of emotion indicators and the exaggeration level, a plurality of space configuration values for each space point, determine final configuration values corresponding to the each of one or more avatars based on a correlation between an initial configuration values assigned to the each of one or more avatars and the space configuration values corresponding to each of the plurality of avatars and exaggerate the one or more avatars based on the final configuration values.

In an embodiment, the conversational data includes at least text data, audio data, or video data. In an embodiment, the plurality of parameters associated with the emotional reaction state includes an emotional valence parameter, an emotional arousal parameter, and a probability of the emotional reaction state of the one or more avatars. In an embodiment, for determination the emotional reaction state associated with each of the one or more avatars, the one or more processors are configured to: perform the contextual analysis of the conversational data and the relational data and determine the plurality of parameters associated with the emotional reaction state based on the contextual analysis.

In an embodiment, the emotional reaction state indicates a reaction of the one or more avatars in response to the conversational data. In an embodiment, the emotional valence parameter indicates a measure of pleasure of the one or more avatars. In an embodiment, the emotional arousal parameter indicates a physiological state of the one or more avatars. In an embodiment, the physiological state of the one or more avatars indicates one of a proactive or inactive state of the one or more avatars.

In an embodiment, the exaggeration level is determined based on each of the emotional reaction state, the probability of the emotional reaction state of the one or more avatars, and the relational data. In an embodiment, the exaggeration level indicates a measure of extremeness of intensity associated with the emotional reaction state. In an embodiment, the measure of extremeness of intensity is a measure that is required to showcase a reaction of the one or more avatars during the real time conversation.

In an embodiment, the plurality of emotion indicators with respect to the emotional reaction state is determined based on the emotional valence parameter and the emotional arousal parameter. In an embodiment, the plurality of emotion indicators indicates a plurality of reaction parameters that are likely to be affected with respect to the emotional reaction state. In an embodiment, the plurality of reaction parameters includes one or more of a color of a skin of the one of more avatars, a plurality of body attributes of the one of more avatars, a temperature associated with the plurality of body attributes of the one of more avatars, a plurality of symbols with respect to the emotional reaction state, a charge associated with the plurality of body attributes of the one of more avatars, or a gravity of the associated with the plurality of body attributes of the one of more avatars.

In an embodiment, the one or more processors are configured to: correlate the plurality of reaction parameters with respect to the emotional reaction state based on the emotional valence parameter and the emotional arousal parameter and determine the plurality of emotion indicators with respect to the emotional reaction state based on a result of the correlation.

In an embodiment, the one or more processors are configured to configure the plurality of space parameters for each space point among the plurality of space points with respect to the plurality of emotion indicators and the exaggeration level. In an embodiment, the plurality of space parameters includes at least a plurality of pixel values, a temperature associated with each space point, a charge associated with each space point, and a gravity associated with each space point. In an embodiment, each of the plurality of pixel values represents one of a color among a RGB color space.

In an embodiment, for configuring the plurality of space parameters, the one or more processors are configured to determine a space subset configuration and a space point configuration in the virtual space surrounding to the one or more avatars.

In an embodiment, the space point configuration is determined based on the plurality of emotion indicators, a space-subset value to each of the plurality of subsets, and the exaggeration level.

In an embodiment, the space subset configuration is a configuration of space subset in the virtual space, wherein the space subset corresponds to a space surrounding to the one or more avatars. In an embodiment, for determining the space subset configuration in the virtual space, the one or more processors are configured to: divide the virtual space into a plurality of subsets, assign a space-subset value to each of the plurality of subsets based on a relation between a corresponding subset of the plurality of subsets, and the plurality of emotion indicators, wherein the relation includes an Euclidean distance between a corresponding subset of the plurality of subsets and a corresponding body attribute of the plurality of body attributes, a direction of the corresponding subset of the plurality of subsets with respect to the corresponding body attribute of the plurality of the body attributes of the each of the one or more avatars, wherein the assigned space-subset value is an extra-exaggeration factor that is included in the corresponding subset of the plurality of subsets and determine the space subset configuration in the virtual space based on the assigned space-subset value.

In an embodiment, for determining the final configuration values corresponding to each of the one or more avatars, the one or more processors are configured to: receive a user input including at least avatar's input parameters corresponding to each of the one or more avatars, determine the initial configuration values corresponding to the each of one or more avatars based on an assignment of configuration values to each body point among a plurality of body points in accordance with the user input, determine the correlation between the initial configuration values corresponding to the each of one or more avatars and the space configuration values corresponding to each of the one or more avatars and determine the final configuration values corresponding to each of the one or more avatars based on the correlation between the initial configuration values and the space configuration values.

In an embodiment, the initial configuration values are assigned based on a predefined values defined with respect to at least the avatar's input parameters, the user input, and a normal body values. In an embodiment, the plurality of body points represents a plurality of body elements of the one or more avatars that are used to represent a state of body of the one or more avatars. In an embodiment, the state of the body includes at least a temperature, charge, skin color, hair color, sweat of the one or more avatars.

In an embodiment, the one or more processors are configured to: simulate the exaggerated one or more avatars in the virtual space; and render the simulated exaggerated the one or more avatars in the virtual space.

In an embodiment, for determining the space point configuration, the one or more processors configured to: assign the plurality of space parameters to each space point based on the reaction data and determine the space point configuration based on the assignment, wherein the space point configuration is exaggerated by the space subset value.

1. A method of controlling a reaction of one or more graphical representations in a virtual environment, the method comprising:
obtaining conversational data corresponding to a conversation between two or more graphical representations in a virtual space of the virtual environment and relational data associated with a relation between the one or more graphical representations;
determining an emotional reaction state associated with the one or more graphical representations based on a contextual analysis of the conversational data and the relational data;
determining, based on a plurality of parameters associated with the emotional reaction state, an exaggeration level corresponding to the emotional reaction state and a plurality of emotion indicators with respect to the emotional reaction state;
determining, for the one or more graphical representations based on a plurality of space parameters for a space point among a plurality of space points in the virtual space with respect to the plurality of emotion indicators and the exaggeration level, a plurality of space configuration values for the plurality of space points, respectively;
determining final configuration values corresponding to the one or more graphical representations, respectively, based on a correlation between an initial configuration values assigned to the one or more graphical representations, respectively, and the plurality of space configuration values corresponding to the one or more graphical representations, respectively; and
controlling the reaction reflected by the one or more graphical representations in the virtual space of the virtual environment by simulating the one or more graphical representations adjusted based on the final configuration values.

2. The method of claim 1,
wherein the one or more graphical representations include one or more avatars,
the conversational data includes at least text data, audio data, or video data,
the plurality of parameters associated with the emotional reaction state includes an emotional valence parameter, an emotional arousal parameter, and a probability of the emotional reaction state of the one or more graphical representations, and
wherein determining the emotional reaction state associated with the one or more graphical representations, respectively, comprises:
performing the contextual analysis of the conversational data and the relational data; and
determining the plurality of parameters associated with the emotional reaction state based on the contextual analysis.

3. The method of claim 2, wherein:
the emotional reaction state indicates the reaction of the one or more graphical representations based on the conversational data,
the emotional valence parameter indicates a measure of pleasure of the one or more graphical representations,
the emotional arousal parameter indicates a physiological state of the one or more graphical representations, and
the physiological state of the one or more graphical representations indicates one of a proactive or inactive state of the one or more graphical representations.

4. The method of claim 2,
wherein the relational data is obtained based on at least one of a user input, historical data, or a user profile data,
the exaggeration level is determined based on the emotional reaction state of the one or more graphical representations, the probability of the emotional reaction state of the one or more graphical representations, and the relational data,
the exaggeration level indicates a measure of extremeness of intensity associated with the emotional reaction state, and
the measure of extremeness of intensity is to showcase the reaction of the one or more graphical representations during the conversation.

5. The method of claim 2,
wherein the plurality of emotion indicators with respect to the emotional reaction state is determined based on the emotional valence parameter and the emotional arousal parameter,
the plurality of emotion indicators indicates a plurality of reaction parameters that are likely to be affected with respect to the emotional reaction state, and
the plurality of reaction parameters includes one or more of a color of a skin of the one or more graphical representations, a plurality of body attributes of the one or more graphical representations, a temperature associated with the plurality of body attributes of the one or more graphical representations, a plurality of symbols with respect to the emotional reaction state, a charge associated with the plurality of body attributes of the one or more graphical representations, or a gravity associated with the plurality of body attributes of the one or more graphical representations.

6. The method of claim 5, wherein the method further comprising:
correlating the plurality of reaction parameters with respect to the emotional reaction state based on the emotional valence parameter and the emotional arousal parameter; and
determining the plurality of emotion indicators with respect to the emotional reaction state based on a result of the correlation.

7. The method of claim 1,
wherein determining the plurality of space configuration values comprises configuring the plurality of space parameters for each space point among the plurality of space points with respect to the plurality of emotion indicators and the exaggeration level,
the plurality of space parameters includes at least a plurality of pixel values, a temperature associated with each space point, a charge associated with each space point, and a gravity associated with each space point, and
each of the plurality of pixel values represents one of a color among a RGB color space.

8. The method of claim 7, wherein configuring the plurality of space parameters comprises determining a space subset configuration and a space point configuration in the virtual space surrounding to the one or more graphical representations.

9. The method of claim 8, wherein the space point configuration is determined based on the plurality of emotion indicators, a space-subset value of a plurality of subsets, and the exaggeration level.

10. The method of claim 9,
wherein the space subset configuration is a configuration of space subset in the virtual space, the space subset corresponding to a space surrounding to the one or more graphical representations,
wherein determining the space subset configuration in the virtual space comprises:
dividing the virtual space into the plurality of subsets;
assigning a space-subset value to the plurality of subsets, respectively, based on a relation between a corresponding subset of the plurality of subsets, and the plurality of emotion indicators, the relation including an Euclidean distance between a corresponding subset of the plurality of subsets and a corresponding body attribute of a plurality of body attributes, a direction of the corresponding subset of the plurality of subsets with respect to the corresponding body attribute of the plurality of body attributes of the one or more graphical representations, the assigned space-subset value being an extra-exaggeration factor that is included in the corresponding subset of the plurality of subsets; and
determining the space subset configuration in the virtual space based on the assigned space-subset value.

11. The method of claim 8, wherein determining the final configuration values corresponding to each of the one or more graphical representations comprises:
receiving a user input including at least avatar's input parameters corresponding to the one or more graphical representations;
determining the initial configuration values assigned to at least one body point of the one or more graphical representations, among a plurality of body points of the one or more graphical representations, in accordance with the user input;
determining the correlation between the initial configuration values assigned to the one or more graphical representations and the plurality of space configuration values corresponding to each of the one or more graphical representations; and
determining the final configuration values corresponding to the one or more graphical representations based on the correlation between the initial configuration values and the plurality of space configuration values.

12. The method of claim 11,
wherein the initial configuration values are assigned based on a predefined values defined with respect to the at least the avatar's input parameters, the user input, and a normal body values,
wherein the plurality of body points represents a plurality of body elements of the one or more graphical representations that are used to represent a state of body of the one or more graphical representations, and
wherein the state of the body includes at least a temperature, charge, skin color, hair color, sweat of the one or more graphical representations.

13. The method of claim 9, wherein determining the space point configuration comprises:
assigning the plurality of space parameters to each space point based on reaction data; and
determining the space point configuration based on the assigning the plurality of space parameters, wherein the space point configuration is exaggerated by the space subset value.

14. A system of controlling a reaction of one or more graphical representations in a virtual environment, the system includes:
a memory to store one or more computer programs; and
one or more processors, communicatively coupled to the memory, to execute the one or more computer programs or at least one instruction stored in the memory to cause the system to:
obtain conversational data corresponding to a conversation between two or more graphical representations in a virtual space of the virtual environment and relational data associated with a relation between the one or more graphical representations;
determine an emotional reaction state associated with the one or more graphical representations based on a contextual analysis of the conversational data and the relational data;
determine, based on a plurality of parameters associated with the emotional reaction state, an exaggeration level corresponding to the emotional reaction state and a plurality of emotion indicators with respect to the emotional reaction state;
determine, for the one or more graphical representations based on configuration of a plurality of space parameters for a space point among a plurality of space points in the virtual space with respect to the plurality of emotion indicators and the exaggeration level, a plurality of space configuration values for the plurality of space points, respectively;
determine final configuration values corresponding to the one or more graphical representations, respectively, based on a correlation between an initial configuration values assigned to the one or more graphical representations and the plurality of space configuration values corresponding to the one or more graphical representations; and
controlling the reaction reflected by the one or more graphical representations in the virtual space of the virtual environment by simulating the one or more graphical representations adjusted based on the final configuration values.

15. One or more non-transitory computer-readable storage media storing one or more computer programs including computer-executable instructions executable by one or more processors of a system to cause the system to perform the method of claim 1.
